(19) United States
(12) Patent Application Publication
(10) Pub. No.: US 2009/0244235 A1
(43) Pub. Date: Oct. 1, 2009

(54) IMAGE FORMING APPARATUS AND METHOD

(76) Inventor: Hiroaki HOUJOU, Kanagawa-ken (JP)

Correspondence Address: BIRCH STEWART KOLASCH & BIRCH, PO BOX 747, FALLS CHURCH, VA, 22040-0747, US

(21) Appl. No.: 12/412,125

(22) Filed: Mar. 26, 2009

(30) Foreign Application Priority Data
Mar. 27, 2008 (JP) 2008-083376

(51) Int. Cl. B41J 2/01

(52) U.S. Cl. 347/102

(57) ABSTRACT

The image forming apparatus forms an image on a recording medium by using an ink and a treatment liquid. The ink contains coloring material, and the treatment liquid contains a component which causes the coloring material to aggregate. The image forming apparatus includes: a treatment liquid deposition device which deposits the treatment liquid onto the recording medium; an ink droplet ejection device which ejects and deposits droplets of the ink onto the recording medium; a plurality of heat fixing devices which perform fixing process of the image formed on the recording medium by removing stepwise a solvent component contained in the image, the heat fixing devices being arranged sequentially in a conveyance direction of the recording medium; and a fixing control device which controls the fixing process with the heat fixing devices so as to satisfy the following condition: if Wᵢ₋₁>50, then Wᵢ₋₁−Wᵢ≦20, where n is a number of the heat fixing devices, Wᵢ (%) is a solvent content rate of the image after the fixing process has been carried out by one of the heat fixing devices in an i-th position (where i is a natural number not larger than n) from an upstream side in the conveyance direction of the recording medium, and W₀ (%) is a solvent content rate of the image before carrying out the fixing process by a first one of the heat fixing devices from the upstream side in the conveyance direction of the recording medium.

### BACKGROUND OF THE INVENTION

1. Field of the Invention

The present invention relates to an image forming apparatus and an image forming method, and more particularly, to technology for fixing an image formed on a recording medium in a two-liquid aggregating system of forming an image on a recording medium by using ink and a treatment liquid.

2. Description of the Related Art

An inkjet recording system performs recording by ejecting and depositing droplets of ink onto a recording medium from a plurality of nozzles formed in an inkjet head, and such a system is able to record images of high resolution and high quality, with little noise during the recording operation and low running costs. The ink ejection method may be, for example, a piezoelectric method, which uses the displacement of a piezoelectric element, or a thermal method, which uses thermal energy generated by a heating element, or the like.

In an inkjet recording system, when depositing ink droplets onto a recording medium such as a permeable medium, for instance, if droplets are deposited consecutively in such a manner that the ink droplets (ink dots) that are mutually adjacent on the recording medium overlap with each other, these ink droplets combine together due to their surface tension and give rise to a problem of bleeding (landing interference) in which the desired dots cannot be formed. In the case of dots of the same color, the dots shape is disturbed and in the case of dots of different colors, an additional problem of color mixing occurs.

As technology for preventing landing interference that occurs between ink droplets (ink dots) on the recording medium, a two-liquid aggregating system using a treatment liquid that reacts with the ink and causes the ink to aggregate has been proposed. For example, Japanese Patent Application Publication No. 2004-010633 discloses technology which uses a reactive liquid (treatment liquid) containing multivalent metal ions. Moreover, Japanese Patent Application Publication No. 2000-037942 discloses technology for improving optical density, bleeding, color mixing and drying duration, by controlling the aggregating properties of pigment on a recording medium through making one of a liquid composition (treatment liquid) and ink acidic and making the other alkaline.

Further, improving the fixing properties of the image formed on the recording medium is one important technology in the inkjet recording system. If the image fixing properties are not sufficient, then this can give rise to image deformation, curling of the recording medium, or the like. For example, Japanese Patent Application Publication No. 2000-155485 discloses an image recording apparatus having a plurality of fixing members, and either all of the fixing members or selected fixing members are used simultaneously during a fixing process. Furthermore, Japanese Patent Application Publication No. 2005-271418 discloses an inkjet recording apparatus having a plurality of fixing rollers, in which one fixing roller is a heating roller, an image on the recording medium being fixed by heating when the recording medium is conveyed between the fixing rollers.

However, if sudden heating is applied in order to fixing an image that has been formed on a recording medium in a two-liquid aggregating system, then new problems emerge, such as the occurrence of image deformation. This is thought to be because of the contraction of the volume of the aggregate image due to the evaporation of solvent.

Moreover, it has been found that when an image formed on a recording medium is fixed by applying heat and pressure using a heat fixing device such as a heating roller, then there is a problem of fold-shaped wrinkles (hereinafter referred to simply as “image folding”) in the image film. This is thought to be because a large amount of solvent remains in the image and therefore protuberances occur in the image film due to the expansion of the solvent when it is vaporized during the heating and pressing process. If fold-shaped wrinkles occur in the image film in this way, then there is marked decline in the fixing properties and luster of the image.

In particular, in cases where the rate of permeation is slow, such as with coated paper, or cases where high-speed recording is carried out, as in a single-pass system, solvent is liable to remain in the image and marked image deformation and image folding occur.

Possible countermeasures for these problems, which might be considered in order to avoid the occurrence of image deformation and image folding, are to omit the fixing step or to lower the fixing temperature, but this naturally results in inadequate fixing properties.

Although Japanese Patent Application Publication Nos. 2000-155485 and 2005-271418 disclose technology for carrying out a fixing process by using a plurality of fixing devices, no mention whatsoever is made of suppressing image deformation or image folding, but in order to control the luster of the fixed image, the fixing process is carried out by merely switching selectively between the fixing devices (roller members) having different characteristics, such as surface roughness and hardness.

There still is no proposed technology capable of ensuring fixing properties while avoiding the occurrence of image deformation and image folding when fixing an image formed on a recording medium by the two-liquid aggregating method.

### SUMMARY OF THE INVENTION

The present invention has been contrived in view of these circumstances, an object thereof being to provide an image forming apparatus and an image forming method whereby image deformation and image folding can be prevented as well as ensuring good fixing properties, in a two-liquid aggregating system which uses ink and a treatment liquid.

In order to attain the aforementioned object, the present invention is directed to an image forming apparatus which forms an image on a recording medium by using an ink and a treatment liquid, the ink containing coloring material, the treatment liquid containing a component which causes the coloring material to aggregate, the apparatus comprising: a treatment liquid deposition device which deposits the treatment liquid onto the recording medium;

an ink droplet ejection device which ejects and deposits droplets of the ink onto the recording medium; a plurality of heat fixing devices which perform fixing process of the image formed on the recording medium by removing stepwise a solvent component contained in the image, the heat fixing devices being arranged sequentially in a conveyance direction of the recording medium; and a fixing control device which controls the fixing process with the heat fixing devices so as to satisfy the following condition:

if Wᵢ₋₁>50, then Wᵢ₋₁−Wᵢ≦20,

where n is a number of the heat fixing devices, Wᵢ (%) is a solvent content rate of the image after the fixing process has been carried out by one of the heat fixing devices in an i-th position (where i is a natural number not larger than n) from an upstream side in the conveyance direction of the recording medium, and W₀ (%) is a solvent content rate of the image before carrying out the fixing process by a first one of the heat fixing devices from the upstream side in the conveyance direction of the recording medium.

According to this aspect of the present invention, the image fixing process is carried out by being divided into a plurality of steps using the plurality of heat fixing devices, and furthermore, the amount of solvent removed from the image in any one of the fixing process steps (the amount of change in the solvent content rate of the image) is restricted to a reference value or lower, and therefore it is possible to prevent image deformation or image folding, as well as ensuring the fixing properties of the image.

In the present specification, the “solvent content rate of the image” is defined as the ratio between the weight M₁ of the image per unit surface area (g/m²) and the weight M₂ of the solvent contained in the image (g/m²) (i.e., M₂/M₁).

For example, the ink contains polymer particles.

When the ink contains polymer particles, it is preferable that the fixing control device controls the fixing process with the heat fixing devices so as to satisfy Wₙ≦25, where Wₙ (%) is a solvent content rate of the image after carrying out the fixing process by one of the heat fixing devices in an n-th position from the upstream side in the conveyance direction of the recording medium.

According to this aspect of the present invention, it is possible to ensure satisfactory fixing properties while preventing image deformation or image folding.

It is also preferable that the ink does not contain polymer particles; and the fixing control device controls the fixing process with the heat fixing devices so as to satisfy Wₙ≦15, where Wₙ (%) is a solvent content rate of the image after carrying out the fixing process by one of the heat fixing devices in an n-th position from the upstream side in the conveyance direction of the recording medium.

According to this aspect of the present invention, it is possible to ensure satisfactory fixing properties while preventing image deformation or image folding.

Preferably, one of the heat fixing devices in an n-th position from the upstream side in the conveyance direction of the recording medium is a heating and pressing device which fixes the image formed on the recording medium by heating and pressing the image.

Preferably, at least one of the fixing devices in the i-th position (excluding a case where i=n) is a heating and pressing device which fixes the image formed on the recording medium by heating and pressing the image.

By using the heating and pressing device, it is possible to increase the adhesiveness between the recording medium and the image and to ensure satisfactory fixing properties.

Preferably, the image forming apparatus further comprises a heating device which applies heat from a side opposite to an image forming surface of the recording medium.

By raising the temperature of the recording medium as such in the stage where the fixing process is carried out (or before this stage), then it is possible to ensure fixing properties are achieved more quickly.

It is also preferable that the ink contains polymer particles; and a heating temperature of the heating device is lower than a glass transition temperature of the polymer particles.

According to this aspect of the present invention, it is possible to ensure fixing properties while also preventing the adherence of the image to the conveyance member of the recording medium.

Preferably, the image forming apparatus further comprises a treatment liquid drying device which dries the treatment liquid deposited on the recording medium and renders the treatment liquid to a solid or semi-solid state.

According to this aspect of the present invention, it is possible to reduce the solvent content in the image in advance, and thus make it less liable that image deformation or image folding will occur. Furthermore, the droplets of ink can be deposited in a state where the solid or semi-solid aggregating treatment agent layer (a thin film layer of dried treatment liquid) has been formed on the surface of the recording medium, and hence deterioration of the image due to movement of the coloring material can be prevented and images of high quality can be formed.

Preferably, the recording medium is a coated paper.

Preferably, the ink droplet ejection device ejects droplets of the ink by a single-pass method.

In order to attain the aforementioned object, the present invention is also directed to a method of forming an image on a recording medium by using an ink and a treatment liquid, the ink containing coloring material, the treatment liquid containing a component which causes the coloring material to aggregate, the method comprising: a treatment liquid deposition step of depositing the treatment liquid onto the recording medium; an ink droplet deposition step of ejecting and depositing droplets of the ink onto the recording medium; and a fixing step of performing fixing process of the image formed on the recording medium by removing stepwise a solvent component contained in the image by heat fixing devices arranged sequentially in a conveyance direction of the recording medium, wherein the fixing process with the heat fixing devices is controlled to satisfy the following condition:

if Wᵢ₋₁>50, then Wᵢ₋₁−Wᵢ≦20,

where n is a number of the heat fixing devices, Wᵢ (%) is a solvent content rate of the image after the fixing process has been carried out by one of the heat fixing devices in an i-th position (where i is a natural number not larger than n) from an upstream side in the conveyance direction of the recording medium, and W₀ (%) is a solvent content rate of the image before carrying out the fixing process by a first one of the heat fixing devices from the upstream side in the conveyance direction of the recording medium.

According to the present invention, the image fixing process is carried out by being divided into a plurality of steps using a plurality of heat fixing devices, and furthermore, the amount of liquid removed from the image in any one fixing process step (the amount of change in the solvent content rate of the image) is restricted to a reference value or lower, and therefore it is possible to prevent image deformation or image folding, as well as ensuring the fixing properties of the image.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a simplified schematic drawing showing an image forming apparatus according to an embodiment of the present invention;

FIG. 2A is a diagram showing a state of an ink droplet landing on a recording medium in the related art, and FIG. 2B is a diagram showing a state of an ink droplet landing on a recording medium according to an embodiment of the present invention;

FIG. 3 is a diagram showing the evaluation results when a fixing process was carried out using one or two heat fixing devices;

FIG. 4 is a diagram showing the evaluation results when a fixing process was carried out using four heat fixing devices;

FIG. 5 is a diagram showing the evaluation results when a fixing process was carried out using heat fixing devices or different types of fixing devices;

FIG. 6 is a diagram showing the evaluation results when a treatment liquid drying step was included or omitted;

FIG. 7 is a diagram showing the evaluation results when the heating temperature applied to the rear surface side of a recording medium was altered;

FIG. 8 is a general schematic drawing showing an inkjet recording apparatus according to an embodiment of the present invention;

FIGS. 9A to 9C are plan view perspective diagrams showing compositions of inkjet heads;

FIG. 10 is a cross-sectional diagram along line 10-10 in FIGS. 9A and 9B; and

FIG. 11 a principal block diagram showing a system configuration of the inkjet recording apparatus shown in FIG. 8.

### DETAILED DESCRIPTION OF THE PREFERRED EMBODIMENTS

Firstly, the ink and the aggregating treatment liquid (hereinafter also referred to simply as “treatment liquid”) used in an embodiment of the present invention will be described.

### Ink

The ink used in the present embodiment is water-based pigment ink that contains the following materials insoluble to the solvent (water): pigment particles as the coloring material, and polymer particles.

It is desirable that the concentration of the solvent-insoluble materials in the ink is not less than 1 wt % and not more than 20 wt %, taking account of the fact that the viscosity of the ink suitable for ejection is 20 mPa·s or lower. It is more desirable that the concentration of the pigment in the ink is not less than 4 wt %, in order to obtain good optical density in the image. It is desirable that the surface tension of the ink is not less than 20 mN/m and not more than 40 mN/m, taking account of ejection stability.

The coloring material in the ink may be pigment or a combination of pigment and dye. From the viewpoint of the aggregating characteristics when the ink comes into contact with the treatment liquid, a dispersed pigment in the ink is desirable for more effective aggregation. Desirable pigments include: a pigment dispersed by a dispersant, a self-dispersing pigment, a pigment in which the pigment particle is coated with a resin (hereinafter referred to as “microcapsule pigment”), and a polymer grafted pigment. Moreover, from the viewpoint of the aggregating characteristics of the coloring material, it is more desirable that the coloring material is modified with a carboxyl group having a low degree of disassociation.

There are no particular restrictions on the resin used for a microcapsule pigment, but desirably, it should be a compound of high molecular weight which has a self-dispersing capability or solubility in water, and contains an anionic group (acidic). Generally, it is desirable that the resin should have a number average molecular weight in the approximate range of 1,000 to 100,000, and especially desirably, in the approximate range of 3,000 to 50,000. Moreover, desirably, this resin can dissolved in an organic solvent to form a solution. By limiting the number average molecular weight of the resin to this range, it is possible to make the resin display satisfactory functions as a covering film for the pigment particle, or as a coating film in the ink composition.

The resin may itself have a self-dispersing capability or solubility, or these functions may be added or introduced. For example, it is possible to use a resin having an introduced carboxyl group, sulfonic acid group, or phosphonic acid group or another anionic group, by neutralizing with an organic amine or alkali metal. Moreover, it is also possible to use a resin into which one or two or more anionic groups of the same type or different types have been introduced. In the embodiment of the present invention, it is desirable to use a resin which has been neutralized by means of a salt and which contains an introduced carboxyl group.

There are no particular restrictions on the pigment used in the present embodiment, and specific examples of orange and yellow pigments are: C. I. Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 17, C. I. Pigment Yellow 74, C. I. Pigment Yellow 93, C. I. Pigment Yellow 94, C. I. Pigment Yellow 128, C. I. Pigment Yellow 138, C. I. Pigment Yellow 151, C. I. Pigment Yellow 155, C. I. Pigment Yellow 180, and C.I. Pigment Yellow 185.

Specific examples of red and magenta pigments are: C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 166, C. I. Pigment Red 177, C. I. Pigment Red 178, and C.I. Pigment Red 222.

Specific examples of green and cyan pigments are: C. I. Pigment Blue 15, C. I. Pigment Blue 15:2, C. I. Pigment Blue 15:3, C. I. Pigment Blue 16, C. I. Pigment Blue 60, and C.I. Pigment Green 7.

Specific examples of a black pigment are: C.I. Pigment Black 1, C.I. Pigment Black 6, and C.I. Pigment Black 7.

It is desirable in the present embodiment that the ink contains polymer particles that do not contain any colorant, as a component for reacting with the treatment liquid. The polymer particles can improve the image quality by strengthening the ink viscosity raising action and the aggregating action through reaction with the treatment liquid. In particular, a highly stable ink can be obtained by adding anionic polymer particles to the ink.

By using the ink containing the polymer particles that produce the viscosity raising action and the aggregating action through reaction with the treatment liquid, it is possible to increase the quality of the image, and at the same time, depending on the type of polymer particles, the polymer particles may form a film on the recording medium, and therefore beneficial effects can be obtained in improving the wear resistance and the waterproofing characteristics of the image.

The method of dispersing the polymer particles in the ink is not limited to adding an emulsion of the polymer particles to the ink, and the resin may also be dissolved, or included in the form of a colloidal dispersion, in the ink.

The polymer particles may be dispersed by using an emulsifier, or the polymer particles may be dispersed without using any emulsifier. For the emulsifier, a surface active agent of low molecular weight is generally used, and it is also possible to use a surface active agent of high molecular weight. It is also desirable to use a capsule type of polymer particles having an outer shell composed of acrylic acid, methacrylic acid, or the like (core-shell type of polymer particles in which the composition is different between the core portion and the outer shell portion).

The polymer particles dispersed without any surface active agent of low molecular weight are known as the soap-free latex, which includes polymer particles with no emulsifier or a surface active agent of high molecular weight. For example, the soap-free latex includes polymer particles that use, as an emulsifier, the above-described polymer having a water-soluble group, such as a sulfonic acid group or carboxylic acid group (a polymer with a grafted water-soluble group, or a block polymer obtained from a monomer having a water-soluble group and a monomer having an insoluble part).

It is especially desirable in the present embodiment to use the soap-free latex compared to other type of resin particles obtained by polymerization using an emulsifier, since there is no possibility that the emulsifier inhibits the aggregating reaction and film formation of the polymer particles, or that the free emulsifier moves to the surface after film formation of the polymer particles and thereby degrades the adhesive properties between the recording medium and the ink aggregate in which the coloring material and the polymer particles are combined.

Examples of the resin component added as the resin particles to the ink include: an acrylic resin, a vinyl acetate resin, a styrene-butadiene resin, a vinyl chloride resin, an acryl-styrene resin, a butadiene resin, and a styrene resin.

In order to make the polymer particles have high speed aggregation characteristics, it is desirable that the polymer particles contain a carboxylic acid group having a low degree of disassociation. Since the carboxylic acid group is readily affected by change of pH, then the polymer particles containing the carboxylic acid group easily change the state of the dispersion and have high aggregation characteristics.

The change in the dispersion state of the polymer particles caused by change in the pH can be adjusted by means of the component ratio of the polymer particle having a carboxylic acid group, such as ester acrylate, or the like, and it can also be adjusted by means of an anionic surfactant which is used as a dispersant.

Desirably, the resin constituting the polymer particles is a polymer that has both of a hydrophilic part and a hydrophobic part. By incorporating a hydrophobic part, the hydrophobic part is oriented toward to the inner side of the polymer particle, and the hydrophilic part is oriented efficiently toward the outer side, thereby having the effect of further increasing the change in the dispersion state caused by change in the pH of the liquid. Therefore, aggregation can be performed more efficiently.

Examples of commercially available resin emulsion include: Joncryl 537 and 7640 (styrene-acrylic resin emulsion, manufactured by Johnson Polymer), Microgel E-1002 and E-5002 (styrene-acrylic resin emulsion, manufactured by Nippon Paint), Voncoat 4001 (acrylic resin emulsion, manufactured by Dainippon Ink and Chemicals), Voncoat 5454 (styrene-acrylic resin emulsion, manufactured by Dainippon Ink and Chemicals), SAE-1014 (styrene-acrylic resin emulsion, manufactured by Zeon Japan), Jurymer ET-410 (acrylic resin emulsion, manufactured by Nihon Junyaku), Aron HD-5 and A- 104 (acrylic resin emulsion, manufactured by Toa Gosei), Saibinol SK-200 (acrylic resin emulsion, manufactured by Saiden Chemical Industry), and Zaikthene L (acrylic resin emulsion, manufactured by Sumitomo Seika Chemicals). However, the resin emulsion is not limited to these examples.

The weight ratio of the polymer particles to the pigment is desirably 2:1 through 1:10, and more desirably 1:1 through 1:3. If the weight ratio of the polymer particles to the pigment is less than 2:1, then there is no substantial improvement in the aggregating force of the aggregate formed by the cohesion of the polymer particles. On the other hand, if the weight ratio of the polymer particles to the pigment is greater than 1:10, the viscosity of the ink becomes too high and the ejection characteristics, and the like, deteriorate.

From the viewpoint of the adhesive force after the cohesion, it is desirable that the molecular weight of the polymer particles added to the ink is no less than 5,000. If it is less than 5,000, then beneficial effects are insufficient in terms of improving the internal aggregating force of the ink aggregate, achieving good fixing characteristics after transfer to the recording medium, and improving the image quality.

It is desirable that the volume-average particle size of the polymer particles is smaller than 1 μm. If the particle size is not smaller than 1 μm, then there is a possibility that the ejection characteristics from the ink head or the storage stability will deteriorate. There are no particular restrictions on the volume-average particle size distribution of the polymer particles and they may have a broad volume-average particle size distribution or they may have a monodisperse volume-average particle size distribution.

Moreover, two or more types of polymer particles may be used in combination in the ink.

Examples of the pH adjuster added to the ink in the present embodiment include an organic base and an inorganic alkali base, as a neutralizing agent. In order to improve storage stability of the ink for inkjet recording, the pH adjuster is desirably added in such a manner that the ink for inkjet recording has the pH of 6 through 10.

It is desirable in the present embodiment that the ink contains a water-soluble organic solvent, from the viewpoint of preventing nozzle blockages in the ejection head due to drying. Examples of the water-soluble organic solvent include a wetting agent and a penetrating agent.

Examples of the water-soluble organic solvent in the ink are: polyhydric alcohols, polyhydric alcohol derivatives, nitrous solvents, monohydric alcohols, and sulfurous solvents. Specific examples of the polyhydric alcohols are: ethylene glycol, diethylene glycol, propylene glycol, butylene glycol, triethylene glycol, 1,5-pentane diol, 1,2,6-hexane triol, and glycerin. Specific examples of the derivatives of polyhydric alcohol are: ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, and an ethylene oxide adduct of diglycerin. Specific examples of the nitrous solvents are: pyrrolidone, N-methyl-2-pyrrolidone, cyclohexyl pyrrolidone, and triethanol amine. Specific examples of the monohydric alcohols are: ethanol, isopropyl alcohol, butyl alcohol, benzyl alcohol, and the like. Specific examples of the sulfurous solvents are: thio diethanol, thio diglycerol, sulfolane, and dimethyl sulfoxide. Apart from these, it is also possible to use propylene carbonate, ethylene carbonate, or the like.

From the viewpoint of the prevention of curl, it is desirable that the water-soluble organic solvent in the ink used in the present embodiment has the SP value of not higher than 27.5. It is also applicable to the water-soluble organic solvent in the treatment liquid described later.

In the present specification, the SP value is the solubility parameter (SP) value of the solvent, and is a value expressed as the square root of the molecular aggregation energy. The SP value is described in Polymer Handbook (Second Edition), Chapter IV, “Solubility Parameter Values”, and the values in the book are referenced in the present specification. The unit of the SP value is (MPa)^{1/2}, and the value at 25° C. is used.

For the SP values of which data are not mentioned in Polymer Handbook, the values calculated by the method proposed in R. F. Fedors, Polymer Engineering And Science, 14 (2), 147 (1974), are used in the present specification.

Next, examples of the water-soluble organic solvents having the SP values of 27.5 or lower are listed as follows; however, the present invention is not limited to them. Their SP values are shown in parentheses.
diethylene glycol monoethyl ether (DEGmEE) (22.4);
diethylene glycol monobutyl ether (DEGmBE) (21.5);
diethylene glycol diethyl ether (DEGdEE) (16.8);
triethylene glycol monobutyl ether (TEGmBE) (21.1);
propylene glycol monoethyl ether (PGmEE) (22.3);
dipropylene glycol (DPG) (27.1);
dipropylene glycol monomethyl ether (DPGmME) (21.3);
tripropylene glycol (TPG) (24.7);
1,2-hexane diol (27.4);
trioxypropylene glyceryl ether (26.4; e.g., GP-250 made by Sanyo Chemical Industries);
hexaoxypropylene glyceryl ether (23.2; e.g., GP-400 made by Sanyo Chemical Industries);
hexadecaoxypropylene glyceryl ether (20.2; e.g., GP-1000 made by Sanyo Chemical Industries);
dioxyethylene-dioxypropylene butyl ether (20.1; e.g., 50HB-55 made by Sanyo Chemical Industries); and
decaoxyethylene-heptaoxypropylene butyl ether (19.0; e.g., 50HB-260 made by Sanyo Chemical Industries).

The ink used in the present embodiment may contain a surfactant.

Examples of the surfactant in the ink include: in a hydrocarbon system, an anionic surfactant, such as a salt of a fatty acid, an alkyl sulfate ester salt, an alkyl benzene sulfonate salt, an alkyl naphthalene sulfonate salt, a dialkyl sulfosuccinate salt, an alkyl phosphate ester salt, a naphthalene sulfonate/formalin condensate, and a polyoxyethylene alkyl sulfonate ester salt; and a non-ionic surfactant, such as a polyoxyethylene alkyl ether, a polyoxyethylene alkyl aryl ether, a polyoxyethylene fatty acid ester, a sorbitan fatty acid ester, a polyoxyethylene sorbitan fatty acid ester, a polyoxyethylene alkyl amine, a glycerin fatty acid ester, and an oxyethylene oxypropylene block copolymer. Desirable examples of the surfactant further include: Surfynols (manufactured by Air Products & Chemicals), which is an acetylene-based polyoxyethylene oxide surfactant, and an amine oxide type of amphoteric surfactant, such as N,N-dimethyl-N-alkyl amine oxide.

Moreover, it is also possible to use the surfactants cited in Japanese Patent Application Publication No. 59-157636, pages 37 to 38, and Research Disclosure No. 308119 (1989). Furthermore, it is also possible to use a fluoride type (alkyl fluoride type), or silicone type of surfactant such as those described in Japanese Patent Application Publication Nos. 2003-322926, 2004-325707 and 2004-309806. It is also possible to use a surface tension adjuster of this kind as an anti-foaming agent; and a fluoride or silicone compound, or a chelating agent, such as ethylenediamine tetraacetic acid (EDTA), can also be used.

The surfactant contained in the ink has beneficial effects in raising the wetting properties on the solid or semi-solid aggregating treatment agent layer by reducing the surface tension, and therefore the aggregating action effectively progresses due to the increase in the contact surface area between the solid or semi-solid aggregating treatment agent layer and the ink.

It is desirable in the present embodiment that the ink has the surface tension of 10 mN/m through 50 mN/m; and from the viewpoint of achieving good permeability into the permeable recording medium, formation of fine droplets and good ejection properties, the surface tension of the ink is more desirably 15 mN/m through 45 mN/m.

It is desirable in the present embodiment that the ink has the viscosity of 1.0 mPa·s through 20.0 mPa·s.

Apart from the foregoing, according to requirements, it is also possible that the ink contains a pH buffering agent, an anti-oxidation agent, an antibacterial agent, a viscosity adjusting agent, a conductive agent, an ultraviolet absorbing agent, or the like.

### Treatment Liquid

It is desirable in the present embodiment that the treatment liquid (aggregating treatment liquid) has effects of generating aggregation of the pigment and the polymer particles contained in the ink by producing a pH change in the ink when coming into contact with the ink.

Specific examples of the contents of the treatment liquid are: polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furan carboxylic acid, pyridine carboxylic acid, cumaric acid, thiophene carboxylic acid, nicotinic acid, derivatives of these compounds, and salts of these.

A treatment liquid having added thereto a polyvalent metal salt or a polyallylamine is the preferred examples of the treatment liquid. The aforementioned compounds may be used individually or in combinations of two or more thereof.

From the standpoint of aggregation ability with the ink, the treatment liquid preferably has a pH of 1 to 6, more preferably a pH of 2 to 5, and even more preferably a pH of 3 to 5.

The amount of the component that causes aggregation of the pigment and polymer particles of the ink in the treatment liquid is preferably not less than 0.01 wt % and not more than 20 wt % based on the total weight of the liquid. Where the amount of this component is less than 0.01 wt %, sufficient concentration diffusion does not proceed when the treatment liquid and ink come into contact with each other, and sufficient aggregation action caused by pH variation sometimes does not occur. Further, where the amount of this component is more than 20 wt %, the ejection ability from the inkjet head can be degraded.

From the standpoint of preventing the nozzles of inkjet heads from being clogged by the dried treatment liquid, it is preferred that the treatment liquid include an organic solvent capable of dissolving water and other additives. A wetting agent and a penetrating agent are included in the organic solvent capable of dissolving water and other additives.

The solvents can be used individually or in a mixture of plurality thereof together with water and other additives.

The content ratio of the organic solvent capable of dissolving water and other additives is preferably not more than 60 wt % based on the total weight of the treatment liquid. Where this amount is higher than 60 wt %, the viscosity of the treatment liquid increases and ejection ability from the inkjet head can be degraded.

In order to improve fixing ability and abrasive resistance, the treatment liquid may further include a resin component. Any resin component may be employed, provided that the ejection ability from a head is not degraded when the treatment liquid is ejected by an inkjet system and also provided that the treatment liquid will have high stability in storage. Thus, water-soluble resins and resin emulsions can be freely used.

An acrylic resin, a urethane resin, a polyester, a vinyl resin, and a styrene resin can be considered as the resin components. In order to demonstrate a sufficient function of improving the fixing ability, a polymer with a comparatively high molecular weight has to be added at a high concentration of 1 wt % to 20 wt %. However, where such a material is added to and dissolved in a liquid, the viscosity thereof increases and ejection ability is degraded. A latex can be effectively added as an adequate material that can be added to a high concentration, while inhibiting the increase in viscosity. Examples of latex materials include alkyl acrylate copolymers, carboxy-modified SBR (styrene-butadiene latex), SIR (styrene-isoprene) latex, MBR (methyl methacrylate-butadiene latex), and NBR (acrylonitrile-butadiene latex). From the standpoint of the process, the glass transition temperature Tg of the latex has a strong effect during fixing, and is desirably not lower than 40° C. and not higher than 120° C. Furthermore, from the standpoint of the process, the minimum film-formation temperature MFT also has a strong effect during fixing, and in order to obtain sufficient fixing at a low temperature, it is preferred that the MFT be not higher than 100° C., more preferably not higher than 50° C.

The aggregation ability may be further improved by introducing polymer microparticles of reverse polarity with respect to that of the ink into the treatment liquid and causing the aggregation of the pigment contained in the ink with the polymer microparticles.

The aggregation ability may be also improved by introducing a curing agent corresponding to the polymer microparticle component contained in the ink into the treatment liquid, bringing the two liquids into contact, causing aggregation and also crosslinking or polymerization of the resin emulsion in the ink component.

The treatment liquid used in the present embodiment can include a surfactant.

Examples of suitable surfactants of a hydrocarbon system include anionic surfactants such as fatty acid salts, alkylsulfuric acid esters and salts, alkylbenzenesulfonic acid salts, alkylnaphthalenesulfonic acid salts, dialkylsulfosuccinic acid salts, alkylphosphoric acid esters and salts, naphthalenesulfonic acid formalin condensate, and polyoxyethylene alkylsulfuric acid esters and salts, and nonionic surfactants such as polyoxyethyelene alkyl ethers, polyoxyethylene alkylallyl ethers, polyoxyethylene fatty acid esters, sorbitan fatty acid esters, polyoxyethylene sorbitan fatty acid esters, polyoxyethylene alkylamines, glycerin fatty acid esters, and oxyethylene oxypropylene block copolymer. It is preferred that SURFYNOLS (made by Air Products & Chemicals), which is an acetylene-type polyoxyethylene oxide surfactant, be used. Amineoxide-type amphoteric surfactant such as N,N-dimethyl-N-alkylamineoxide is also a preferred surfactant.

A surfactant described in Japanese Patent Application Publication No. 59-157636, pages 37 to 38 and Research Disclosure No. 308119 (1989) can be also used. Fluorine-containing (fluorinated alkyl system) and silicone-type surfactants such as described in Japanese Patent Application Publication Nos. 2003-322926, 2004-325707, and 2004-309806 can be also used. These surface tension adjusting agents can be also used as an antifoaming agent. Chelating agents represented by fluorine-containing or silicone-type compounds and EDTA can be also used.

These agents are effective in reducing surface tension and increasing wettability on the image formation body (recording medium, intermediate transfer body, etc.). Further, even when the ink is the first to be deposited, effective aggregation action proceeds because of increased wettability of the ink and enlarged contact surface area of the two liquids.

The surface tension of the treatment liquid in accordance with the present invention is preferably 10 mN/m to 50 mN/m. From the standpoint of improving the wettability on the intermediate transfer body and also size reduction ability and ejection ability of droplets, it is even more preferred that the surface tension be 15 mN/m to 45 mN/m.

The viscosity of the treatment liquid in accordance with the present invention is preferably 1.0 mPa·s to 20.0 mPa·s.

If necessary, a pH buffer agent, an antioxidant, an anti-mold agent, a viscosity adjusting agent, an electrically conductive agent, an ultraviolet agent, and (ultraviolet) absorbent, etc. can be also added.

### Image Forming Method

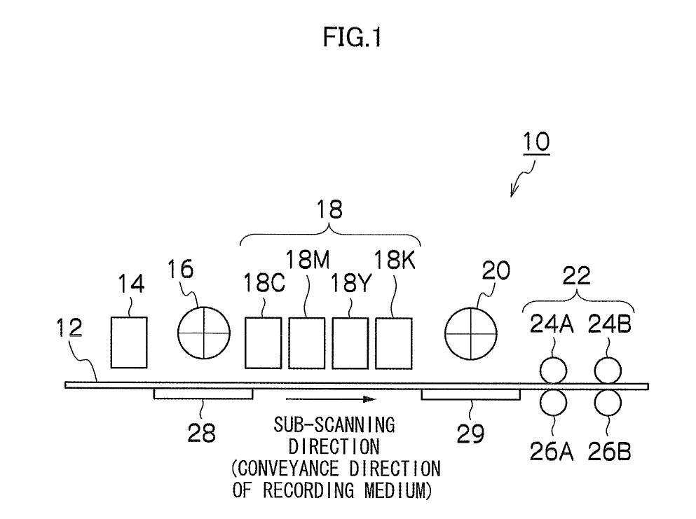

The image forming method according to an embodiment of the present invention will be described with reference to FIG. 1.

An image forming apparatus 10 shown in FIG. 1 includes, in order from the upstream side in the direction of conveyance of a recording medium 12 (the sub-scanning direction), a treatment liquid deposition unit 14, a treatment liquid drying unit 16, an ink droplet ejection unit 18, an ink drying unit 20, and a fixing unit 22.

The treatment liquid deposition unit 14 deposits the treatment liquid onto the recording medium 12 before the deposition of ink droplets by the ink droplet ejection unit 18, which is arranged to the downstream side in the sub-scanning direction. There are no particular restrictions on the method of depositing the treatment liquid, and for example, it is possible to employ an application method using an application roller, or the like, or a spraying method, an inkjet recording method, or other methods of various types. In the present embodiment, droplets of the treatment liquid are ejected and deposited onto the recording medium 12 by using an inkjet type of recording head (hereinafter referred to as a “treatment liquid ejection head”).

The treatment liquid drying unit 16 is disposed to the downstream side of the treatment liquid deposition unit 14 in terms of the sub-scanning direction, whereby the treatment liquid that has been deposited on the recording medium 12 is dried, forming a solid or semi-solid aggregating agent layer (a thin film layer of the dried treatment liquid) on the surface of the recording medium 12. There are no particular restrictions on the method used to dry the treatment liquid, and for example, desirably, a hot air drying method is adopted in which a hot air drying device of which the temperature and air flow rate can be controlled within a prescribed range is provided and a hot air flow is blown onto the treatment liquid on the recording medium 12. Furthermore, it is also desirable to adopt, either in conjunction with the hot air drying method described above, or independently, a rear surface heating method in which a heater (for example, a flat plate heater) 28 is provided on the rear surface side of the recording medium 12 (the side opposite to the image forming surface) and the recording medium 12 is thereby heated from the rear surface side.

In the present specification, the term of “solid or semi-solid aggregating treatment agent (aggregating treatment agent layer)” includes an aggregating treatment agent (aggregating treatment agent layer) having a solvent content rate of 0% to 70%, where the solvent content rate is defined as: “Solvent content rate”=“Weight of solvent contained in treatment liquid after drying, per unit surface area (g/m²)”/“Weight of treatment liquid after drying, per unit surface area (g/m²)”.

The term of “aggregating treatment agent” broadly includes the aggregating treatment agent of the solid or semi-solid state and the aggregating treatment agent in a liquid state. In particular, the aggregating treatment agent in the liquid state of which the solvent content rate is not less than 70% is referred to as an “aggregating treatment liquid”.

As a method for calculating the solvent content rate of the aggregating treatment agent, a sheet of paper of a prescribed size (for example 100 mm×100 mm) is cut out, the total weight of the paper after the deposition of the treatment liquid (the total weight of the paper and the deposited treatment liquid before drying) and the total weight of the paper after drying of the treatment liquid (the total weight of the paper and the deposited and dried treatment liquid) are measured respectively, and the reduction in the amount of solvent due to drying (the amount of solvent evaporated) is determined from the difference between the two weights. Furthermore, the amount of solvent contained in the treatment liquid before drying can be calculated from the treatment liquid preparation method. It is possible to obtain the solvent content rate from the result of these calculations.

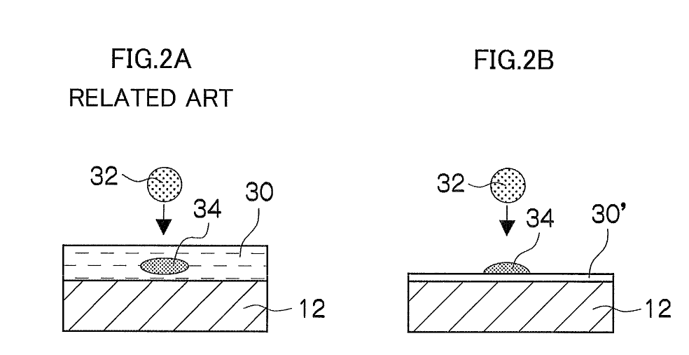

As shown in FIG. 2A, if an ink droplet 32 is deposited in a state where a layer of the treatment liquid (treatment liquid layer) 30 is present on the surface of the recording medium 12, the ink coloring material (ink dots) 34 floats and moves in the treatment liquid layer 30, giving rise to deterioration of the image quality. Therefore, in the image forming apparatus 10 shown in FIG. 1, in order to prevent image deterioration due to movement of the coloring material (floating of the dots), the treatment liquid is dried on the recording medium 12 before ink droplets are deposited onto the recording medium 12, thereby forming the solid or semi-solid aggregating treatment agent layer 30′ on the recording medium 12 as shown in FIG. 2B.

Here, Table 1 shows the evaluation results for movement of the coloring material when the solvent content rate of the treatment liquid (aggregating treatment agent layer) on the recording medium 12 is varied.

TABLE 1

| | Experiment 1 | Experiment 2 | Experiment 3 | Experiment 4 | Experiment 5 |
|---|---|---|---|---|---|
| Drying step | No | Yes | Yes | Yes | Yes |
| Total weight (g/m²) | 10.0 | 6.0 | 4.0 | 3.0 | 1.3 |
| Weight of water (g/m²) | 8.7 | 4.7 | 2.7 | 1.5 | 0 |
| Solvent content rate (%) | 87 | 78 | 67 | 50 | 0 |
| Movement of coloring | Poor | Fair (slight | Good | Excellent | Excellent |
| material | (defective) | movement) | (inconspicuous | | |
| | | | movement) | | |

As shown in Table 1, when the treatment liquid was not dried (Experiment 1), image deterioration occurred due to movement of the coloring material.

On the other hand, when drying of the treatment liquid was carried out (Experiments 2 to 5), then the movement of the coloring material was inconspicuous when the treatment liquid was dried until the solvent content rate in the treatment liquid of 70% or lower, and the movement of the coloring material assumed a satisfactory level that was imperceptible by visual inspection when the treatment liquid was dried until the solvent content rate of 50% or lower. Thus, it was confirmed that that drying of the treatment liquid is effective in preventing image deterioration.

By thereby carrying out drying until the solvent content rate on the recording medium 12 becomes 70% or lower (and desirably, 50% or lower), and thus forming a solid or semi-solid aggregating treatment agent layer on the recording medium 12, it is possible to prevent image deterioration caused by movement of the coloring material.

The ink droplet ejection unit 18 is provided with inkjet type recording heads (hereinafter referred to as “ink ejection heads”) 18C, 18M, 18Y and 18K, which correspond to the respective colored inks of cyan (C), magenta (M), yellow (Y) and black (K), and eject droplets of the corresponding colored inks from the nozzles of the ink ejection heads 18C, 18M, 18Y and 18K in accordance with the input image data. In the present embodiment, the ejection volume (droplet ejection volume) of the ink droplets ejected from the nozzles is 2 pl, and the recording density (droplet deposition density) is 1200 dpi in both the main scanning direction (the direction perpendicular to the conveyance direction of the recording medium 12) and the sub-scanning direction (the conveyance direction of the recording medium 12).

As described above, in the image forming apparatus 10 shown in FIG. 1, the solid or semi-solid aggregating treatment agent layer 30′ is formed on the surface of the recording medium 12, as shown in FIG. 2B. Therefore, when the ink droplets 32 that have been ejected from the ink ejection heads 18C, 18M, 18Y and 18K land on the surface of the solid or semi-solid aggregating treatment agent layer 30′, the coloring material in the ink (ink dots) 34 aggregates instantaneously and image deterioration due to movement of the coloring material (floating of the dots) can be prevented.

The ink drying unit 20 is disposed to the downstream side of the ink droplet ejection unit 18 in terms of the sub-scanning direction, and dries the ink droplets that have been deposited on the recording medium 12. There are no particular restrictions on the ink drying method, but similarly to the treatment liquid drying unit 16, it is desirable to adopt the method which blows hot air onto the ink on the recording medium 12 (hot air drying method). Furthermore, it is also desirable to adopt, either in conjunction with the hot air drying method described above, or independently, the rear surface heating method in which a heater (for example, a flat plate heater) 29 is provided on the rear surface side of the recording medium 12 (the side opposite to the image forming surface) and the recording medium 12 is thereby heated from the rear surface side.

The fixing unit 22 is provided with a plurality of heating rollers 24A and 24B and fixes the image formed on the recording medium 12 by applying heat and pressure to the recording medium 12 that is pressed between the heating rollers 24A and 24B and opposing rollers (back-up rollers) 26A and 26B, which are arranged so as to correspond to the heating rollers 24A and 24B. In the present embodiment, two heating rollers 24A and 24B are provided; however, the invention is not limited to this and it is also possible to provide three or more heating rollers. Furthermore, it is also possible to use a non-contact type of fixing device, such as a heater or hot air drying machine, instead of a contact type of fixing device such as the heating roller.

The heating rollers 24A and 24B are rollers of which the temperature can be controlled in a prescribed range (for example, 50° C. to 180° C.), and the heating temperatures of the heating rollers 24A and 24B should desirably be set in accordance with the glass transition temperature of the polymer particles contained in the treatment liquid or the ink. For instance, the heating temperature of the first heating roller 24A on the upstream side in the sub-scanning direction is set to 60° C., and the heating temperature of the second heating roller 24B on the downstream side is set to 75° C.

The pressure (nip pressure) applied to the recording medium 12 by the heating rollers 24A and 24B is desirably 0.05 MPa to 2.0 MPa. For example, the pressure of the first heating roller 24A is set to 0.1 MPa, and the pressure of the second heating roller 24B is set to 1.0 MPa.

Next, the operation of the image forming apparatus 10 shown in FIG. 1 is described.

The recording medium 12 is conveyed in the sub-scanning direction at a prescribed conveyance speed (for example, 535 mm/s) and the recording medium 12 passes a position opposing the treatment liquid deposition unit 14, then treatment liquid droplets are ejected and deposited onto the recording medium 12 from the treatment liquid ejection head of the treatment liquid deposition unit 14 (treatment liquid deposition step).

Thereupon, when the recording medium 12 passes a position opposing the treatment liquid drying unit 16, the solvent component of the treatment liquid on the recording medium 12 is removed thereby drying the liquid, by hot air drying performed by the treatment liquid drying unit 16. Thereby, the solid or semi-solid aggregating treatment agent layer is formed on the recording medium 12 (treatment liquid drying step).

Thereupon, when the recording medium 12 passes a position opposing the ink droplet ejection unit 18, ink droplets of respective colors are ejected and deposited onto the recording medium 12 from the ink ejection heads 18C, 18M, 18Y and 18K (ink droplet ejection step).

The ink droplets ejected from the ink ejection heads 18C, 18M, 18Y and 18K land on the surface of the solid or semi-solid aggregating treatment agent layer that has been formed on the recording medium 12. At this time, the contact interface between each ink droplet and the aggregating treatment agent layer has a prescribed area when the ink droplet lands, due to a balance between the kinetic energy and the surface energy. The aggregating reaction starts immediately after the ink droplets have landed on the aggregating treatment agent, and the aggregating reaction starts from the surface of each ink droplet in contact with the aggregating treatment agent layer. Since the aggregating reaction occurs only in the vicinity of the contact surface, and the coloring material in the ink aggregates while the ink droplet obtains an adhesive force in the prescribed contact interface area upon landing of the ink droplet, then movement of the coloring material is suppressed.

Even if another ink droplet is subsequently deposited adjacently to the ink droplet deposited previously, since the coloring material of the previously deposited ink has already aggregated, then the coloring material does not mix with the subsequently deposited ink, and therefore bleeding is suppressed. After the aggregation of the coloring material, the separated ink solvent spreads, and a liquid layer containing dissolved aggregating treatment agent is formed on the recording medium 12.

Subsequently, when the recording medium 12 passes a position opposing the ink drying unit 20, the solvent component (liquid component) which has been separated from the ink aggregate on the recording medium 12 is evaporated off and dried by hot air drying by the ink drying unit 20 (ink drying step). As a result, curling of the recording medium 12 is prevented, and furthermore deterioration of the image quality as a result of the presence of the solvent component can be restricted.

Furthermore, when the recording medium 12 passes the fixing unit 22, heating and pressing are carried out sequentially by the first heating roller 24A and the second heating roller 24B arranged following the sub-scanning direction, and the image formed on the recording medium 12 is thereby fixed (image fixing step).

### Image Fixing Step

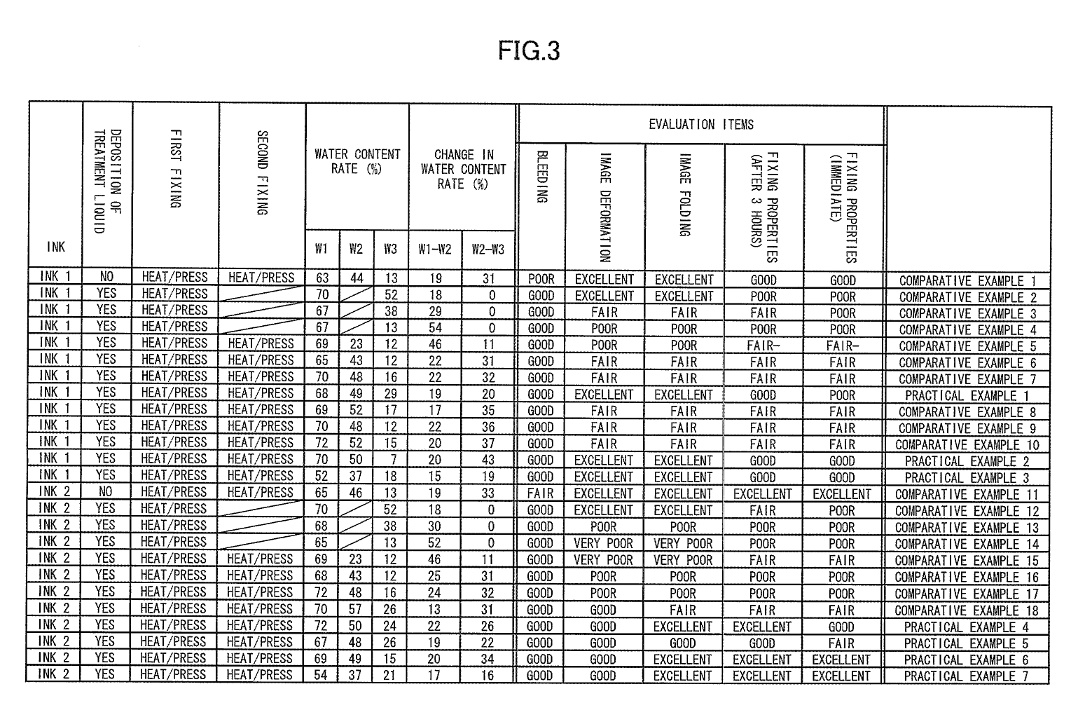

Next, the image fixing step of the present embodiment is described in detail with reference to the results of the evaluation experiments shown in FIGS. 3 to 7.

In the image fixing step, if a fixing process is carried out only once, then it is necessary either to set the heating temperature applied to the recording medium to an extremely high temperature, to raise the applied pressure (nip pressure), or to lengthen the pressing duration (nip duration), in order to promote the fixing of the image formed on the recording medium. However, in a case of this kind, image deformation or image folding become liable to occur since the liquid content contained in the image on the recording medium is removed suddenly in a short period of time.

Therefore, in the present embodiment, the image fixing process is carried out by dividing into a plurality of steps using a plurality of heat fixing devices, and if a large amount of liquid (solvent) is present in the image on the recording medium (if the solvent content rate of the image exceeds 50%), then by restricting the solvent content removed from the image in each fixing process (the amount of change in the solvent content rate of the image) to a reference value or lower, then image fixing properties are ensured while preventing the occurrence of image deformation that is induced by the sudden evaporation of the liquid content or the occurrence of fold-shaped wrinkles (image folding) in the image film that is induced by an excessive fixing temperature, fixing duration or fixing pressure, in cases where a recording medium having non-permeable properties (for example, a coated paper) is used, or cases where high-speed recording is carried out using a single-pass method (for example, a conveyance speed of 535 mm/s).

More specifically, if n heat fixing devices (where n is a natural number larger than one; same applies below) are arranged in the sub-scanning direction, then taking the solvent content rate of the image after carrying out a fixing process by the i-th heat fixing device from the upstream side in the sub-scanning direction (where i is a natural number not larger than n; same applies below) to be Wᵢ (%), and taking the solvent content rate of the image before carrying out a fixing process by the first heat fixing device from the upstream side in the sub-scanning direction to be W₀ (%), then a fixing process is carried out so as to satisfy the following condition (1):

if Wᵢ₋₁>50, then Wᵢ₋₁−Wᵢ≦20. (1)

On the other hand, if the solvent content rate in the image before carrying out the fixing process by the heat fixing devices is small (and more specifically, not higher than 50%), then the possibility of the occurrence of image deformation or image folding is considerably reduced, and therefore the amount of change in the solvent content rate of the image before and after carrying out each fixing process can be set to higher than the reference value (20%).

For example, in the case of the image forming apparatus 10 shown in FIG. 1, taking the solvent content rate of the image before carrying out a fixing process by the first heating roller 24A to be W₀ (%), taking the solvent content rate of the image after carrying out a fixing process by the first heating roller 24A (in other words, the solvent content rate of the image before carrying out a fixing process by the second heating roller 24B) to be W₁ (%), and taking the solvent content rate of the image after carrying out a fixing process by the second heating roller 24B to be W₂ (%), a fixing process is carried out in such a manner that the conditions (2) and (3) below are satisfied:

W₀−W₁≦20 (where W₀>50); and (2)

W₁−W₂≦20 (where W₁>50). (3)

In order to carry out a fixing process of the kind described above, the heating temperature T₁ of the first heating roller 24A on the upstream side in the sub-scanning direction should be set lower than the heating temperature T₂ of the second heating roller 24B on the downstream side (in other words, T₁<T₂). Thereby, even in a state where a large amount of solvent is left remaining in the image, preliminary fixing is carried out and drying is advanced progressively by a first fixing process at a low temperature that does not give rise to image deformation, and the image is then fully fixed by a second fixing process. Therefore, it is possible to ensure image fixing properties while suppressing the occurrence of image deformation and image folding. In the example described here, the heating temperatures of the heating rollers 24A and 24B are controlled; however, the invention is not limited to this and it is also possible to control the applied pressure (nip pressure) or pressing duration of the heating rollers 24A and 24B, or a combination of these, so as to carry out a fixing process that satisfies the above-described condition (1).

In the related art, there is known technology which uses an ink containing polymer particles and improves image fixing properties by carrying out a fixing process at or above the glass transition temperature of the polymer particles. However, when fixing an image formed on a recording medium by a two-liquid aggregating method using ink and a treatment liquid, if the image is heated to the glass transition temperature of the polymer particles or above in a state where the image contains a large amount of solvent (e.g., water), then the polymer particles fuse inside the image and this further encourages the occurrence of image deformation.

In this respect, in the present embodiment, even in cases where an ink containing polymer particles is used, the image fixing process is divided into a plurality of steps using a plurality of heat fixing devices, and furthermore, the fixing process is carried out so as to satisfy the above-described condition (1). Therefore, once the bonding force in the image has been raised to a certain extent by early stages of the fixing process, then even if the image is heated to the glass transition temperature Tg of the polymer particles or higher by the later stages of the fixing process, the polymer particles can be made to fuse sufficiently without the occurrence of image deformation, thus making it possible to ensure satisfactory fixing properties.

In the present embodiment, when using an ink containing polymer particles, taking Wₙ (%) to be the solvent content rate of the image after carrying out a fixing process by a heat fixing device arranged at the n-th position from the upstream side in the sub-scanning direction, of the n heat fixing devices that are arranged in the sub-scanning direction (namely, the heat fixing device at the furthest downstream position in the sub-scanning direction), then it is desirable that a fixing process is carried out so as to satisfy the following condition (4):

Wₙ≦25, (4)

as well as satisfying the above-described condition (1). Due to the effects of the enhanced bonding force created by the polymer particles, even if there is a considerable amount of water in the image after fixing, it is possible to ensure good fixing properties immediately after the end of the whole fixing process.

On the other hand, in the present embodiment, when using an ink that does not contain polymer particles, it is desirable to satisfy the following condition (5) instead of the above-described condition (4):

Wₙ≦15. (5)

Even in cases where the ink does not contain polymer particles, it is still possible to obtain good fixing properties immediately after the image has been fixed and output.

In the image forming apparatus 10 shown in FIG. 1, the heating rollers 24A and 24B (which correspond to the “heating and pressing devices” of the present invention) are provided; however, the present invention is not limited to this and it is also possible to use fixing devices of a non-contact type, which carry out fixing indirectly, such as hot air blowers or heaters.

In the present embodiment, of the n heat fixing devices which are arranged in the sub-scanning direction, the heat fixing device disposed in the n-th position from the upstream side in the sub-scanning direction (in other words, disposed at the furthest downstream side in the sub-scanning direction) is a heating and pressing device that fixes the image by applying heat and pressure to the image formed on the recording medium. Since the image on the recording medium is pressed toward the recording medium in a state where the water content in the image has become low, then it is possible to improve the adhesiveness between the image and the recording medium, and hence beneficial effects are obtained in further improving the fixing properties.

In particular, in the mode described above, it is particularly desirable to adopt a mode in which, not only the heat fixing device disposed in the n-th position from the upstream side in terms of the sub-scanning direction (in other words, the furthest downstream side in the sub-scanning direction), but also at least one of the other heat fixing devices (in other words, the 1st to (n−1)-th heat fixing devices) is a heating and pressing device. By carrying out a fixing process by using a plurality of heating and pressing devices conjointly, it is possible to contract the image on the recording medium in the thickness direction, enhance the bonding force inside the image and also further reduce the residual solvent in the image by pressing out the solvent in the image. This is beneficial for preventing the occurrence of image deformation or image folding during main fixing.

In the present embodiment, a desirable mode is one where the conveyance member of the recording medium (for example, the conveyance belt) is heated, whereby the recording medium is heated from the rear surface side (the side opposite to the image forming surface). For example, it is possible to apply heat during the stage where the fixing process is being carried out by the respective heat fixing devices, or it is possible to carry out preliminary heating at a stage before the fixing process is carried out. Furthermore, it is also possible to carry out heating by combining these modes. By raising the temperature of the recording medium as such at the time that the fixing process is carried out, it is possible to ensure fixing properties even more quickly.

In cases where ink containing polymer particles is used, if an image is to be formed on both surfaces of the recording medium (in other words, in the case of double-side printing), if the conveyance member of the recording medium is heated to the glass transition temperature Tg of the polymer particles or above, then the polymer particles in the image formed on the surface of the recording medium adjacent to the conveyance member will melt and fuse onto the conveyance member, thus causing the image to adhere to the conveyance member. In cases such as these, taking T to be the heating temperature of the conveyance member of the recording medium, the following condition (6) should be satisfied:

T<Tg. (6)

Thereby, it is possible to ensure image fixing properties, while preventing the image from adhering to the conveyance member of the recording medium.

In the present embodiment, a desirable mode is one which includes a step of drying the treatment liquid that has been deposited on the recording medium (treatment liquid drying step), as in the image forming apparatus 10 shown in FIG. 1. By drying the treatment liquid that has been deposited on the recording medium, it is possible to reduce in advance the water content in the image formed on the recording medium, as well as being able to suppress the occurrence of image deformation and image folding. Moreover, by depositing ink droplets after the treatment liquid deposited on the recording medium has been rendered to a solid or semi-solid state, it is possible to prevent image deterioration due to movement of the coloring material and therefore an image of high quality can be formed.

FIGS. 3 to 7 show the evaluation results of evaluation experiments relating to the present invention.

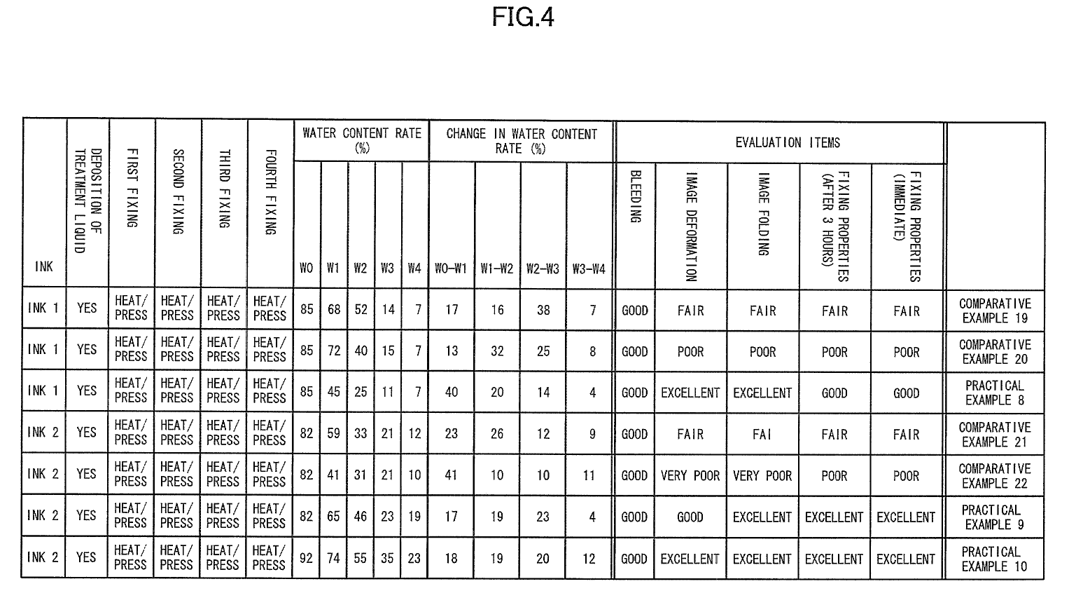

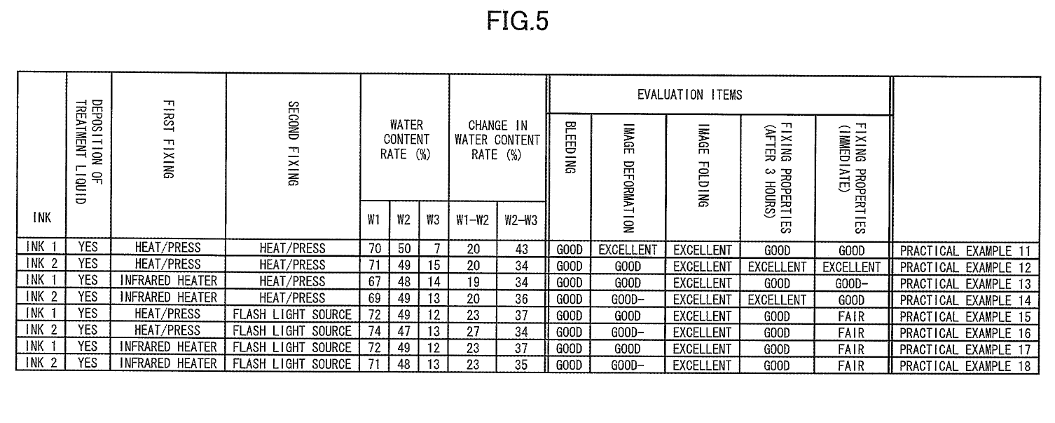

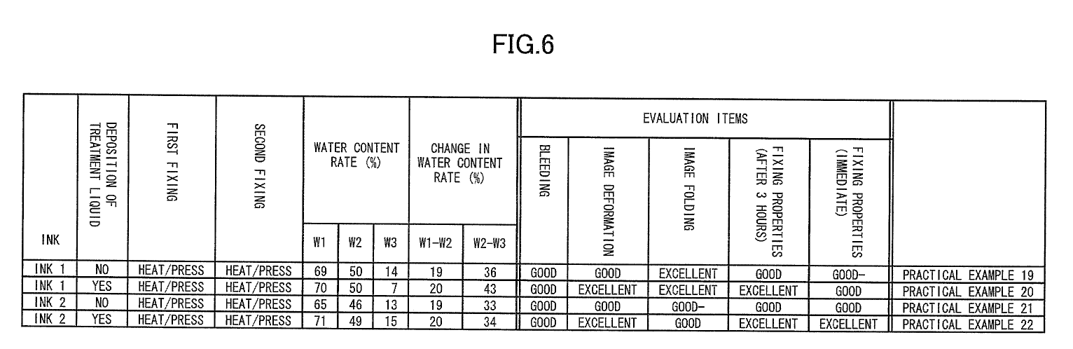

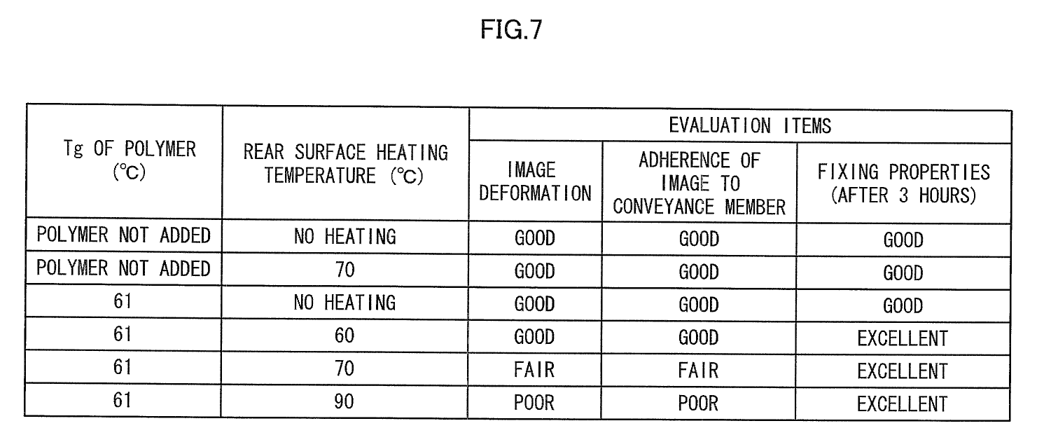

FIGS. 3 and 4 show the evaluation results for cases where a fixing process was carried out using a plurality of heating rollers: FIG. 3 relates to cases where two heating rollers were used, and FIG. 4 relates to cases where four heating rollers were used. FIG. 5 shows the evaluation results for cases where a fixing process was carried out using heat fixing devices of a plurality of different types. FIG. 6 shows the evaluation results for cases where a treatment liquid drying step was included or omitted. FIG. 7 shows the evaluation results in respect of change in the heating temperature applied to the rear surface side of the recording medium (including a case where no heat was applied). Comparative examples 2 to 4 and 12 to 14 shown in FIG. 3 relate to cases where a fixing process was carried out only once using one heating roller.

The treatment liquid and the ink used in the evaluation experiment were as described below.

### Preparation of the Treatment Liquid

A treatment liquid was prepared by mixing together the following materials:

| | |
|---|---|
| Citric acid (made by Wako Pure Chemical Industries): | 16.7% |
| Diethylene glycol monomethyl ether (made by Wako | 20.0% |
| Pure Chemical Industries: | |
| Zonyl FSN-100 (made by Dupont): | 1.0% |
| Deionized water: | 62.3% |

The physical properties of the treatment liquid thus prepared were measured as: the viscosity was 4.9 mPa·s, the surface tension was 24.3 mN/m and the pH was 1.5.

### Preparation of the Ink

### <Preparation of Polymer Dispersant P-1>

88 g of methylehtyl ketone was introduced into a 1000 ml three-mouthed flask fitted with an agitator and cooling tube, and was heated to 72° C. in a nitrogen atmosphere, whereupon a solution formed by dissolving 0.85 g of dimethyl 2,2′-azobis isobutylate, 60 g of benzyl methacrylate, 10 g of methacrylic acid and 30 g of methyl methacrylate in 50 g of methylethyl ketone was added to the flask by titration over three hours. When titration had been completed and after reacting for a further hour, a solution of 0.42 g of dimethyl 2,2′-asobis isobutylate dissolved in 2 g of methylethyl ketone was added, the temperature was raised to 78° C. and the mixture was heated for 4 hours. The reaction solution thus obtained was suspended twice in an excess amount of hexane, and the precipitated resin was dried, yielding 96 g of a polymer dispersant P-1.

The composition of the resin thus obtained was confirmed using a 1H-NMR, and the weight-average molecular weight (Mw) determined by GPC was 44600. Moreover, the acid number of the polymer was 65.2 mg KOH/g as determined by the method described in Japanese Industrial Standards (JIS) specifications (JIS K 0070-1992).

### <Preparation of Cyan Dispersion Liquid>

10 parts of Pigment Blue 15:3 (phthalocyanine blue A220 made by Dainichi Seika Color & Chemicals), 5 parts of the polymer dispersant P-1 obtained as described above, 42 parts of methylethyl ketone, 5.5 parts of an aqueous 1 mol/L NaOH solution, and 87.2 parts of deionized water were mixed together, and dispersed for 2 to 6 hours using 0.1 mm diameter zirconia beads in a beads mill.

The methylethyl ketone was removed from the obtained dispersion at 55° C. under reduced pressure, and moreover a portion of the water was removed, thus obtaining a cyan dispersion liquid having a pigment concentration of 10.2 wt %.

The cyan dispersion liquid forming a coloring material was prepared as described above.

An ink 1 (ink containing no polymer particles) and an ink 2 (ink containing polymer particles) were prepared by mixing together components to achieve the ink compositions described below, using the coloring material (cyan dispersion liquid) obtained as described above.

<Composition of ink 1>

| | |
|---|---|
| Cyan pigment (Pigment Blue 15:3) | 4% |
| Trioxypropylene glyceryl ether (Sannix GP250 (made by | 15% |
| Sanyo Chemical Industries)) | |
| Olefin E1010 (a surfactant, made by Nisshin | 1% |
| Chemical Industry) | |
| Deionized water | remainder |

<Composition of ink 2>

| | |
|---|---|
| Cyan pigment (Pigment Blue 15:3) | 4% |
| Joncryl 537 (styrene-acrylic resin emulsion, made | 8% |
| by Johnson Polymers) | |
| Trioxypropylene glyceryl ether (Sannix GP250 (made by | 15% |
| Sanyo Chemical Industries)) | |
| Olefin E1010 (a surfactant, made by Nisshin | 1% |
| Chemical Industry) | |
| Deionized water | remainder |

The solvent content rate of the image before and after carrying a fixing process by each of the heat fixing devices was calculated by weight measurement using an electronic balance. For example, the solvent content rate of the image after carrying out the first fixing process (in other words, before carrying out the second fixing process) was measured by temporarily interrupting the image forming process (the image fixing step) and measuring the weight.

The assessment method and the assessment criteria of the respective assessment items were as stated below.

### <Bleeding>

A line was printed, and the printed line width was measured at 20 different points and the variation in the line width was calculated.

Good: Variation in line width was not more than 5 μm;

Fair: Variation in line width was more than 5 μm and not more than 10 μm; and

Poor: Variation in line width was more than 10 μm.

### <Image Deformation During Fixing>

The ratio of the surface areas of the image before and after fixing was measured for a 1 mm×1 mm solid image, for which criteria are:

Excellent: Image contraction rate was 1% or lower;

Good: Image contraction rate was 3% or lower;

Fair: Image contraction rate was 5% or lower;

Poor: Image contraction rate was 10% or lower; and

Very Poor: Image contraction rate was over 10%.

### <Image Folding During Fixing>

The state of the occurrence of fold-shaped creases in the surface of the image film before and after fixing of a solid image area was evaluated, for which criteria are:

Excellent: No fold was observed;

Good: Fold was hardly observed;

Fair: Folds occurred in several positions, but of acceptable visibility;

Poor: Folds occurred in portions of the image; and

Very Poor: Folds occurred in the whole of the image.

### <Fixing Properties>

A piece of cellophane tape was attached to a solid image area immediately after the fixing process and three hours after the fixing process, the tape was peeled off at an angle of 90°, and a functional assessment of the extent of adherence of the coloring material to the cellophane tape was made, for which criteria are:

Excellent: No adherence of coloring material at all;

Good: Adherence of coloring material not visible with naked eye;

Fair: Slight adherence of coloring material, but within practical tolerances;

Poor: Severe adherence of coloring material, base surface of recording medium exposed; outside tolerances; and

Very Poor: Virtually all of coloring material adheres to tape; outside tolerances.

As shown in FIGS. 3 and 4, the practical examples of the present invention all satisfied the above-described condition (1), and were able to improve image fixing properties while suppressing the occurrence of image deformation or image folding (practical examples 1 to 10). Of these examples, when using the ink containing polymer particles (ink 2), it was possible to suppress the occurrence of image deformation and image folding if the solvent content rate Wₙ of the image after the last fixing process (W₂ in FIG. 3 and W₄ in FIG. 4; same applies below) was not higher than 25% (practical examples 4, 6, 7, 9 and 10), and when using the ink that does not contain polymer particles (ink 1), it was possible to suppress the occurrence of image deformation and image folding if the solvent content rate W₃ of the image after the last fixing process was not higher than 15% (practical examples 2 and 8).

On the other hand, if an image was formed without using the treatment liquid, then it was not possible to suppress bleeding of the image (comparative examples 1 and 11).

Moreover, when a fixing process was carried out only once (comparative examples 2 to 4 and 12 to 14), if the change in the solvent content rate of the image before and after carrying out the fixing process by each heat fixing device (namely, Wᵢ₋₁−Wᵢ) exceeded 20%, then it was not possible to suppress the occurrence of image deformation or image folding (comparative examples 3, 4, 13 and 14), whereas if the change in the solvent content rate of the image (Wᵢ₋₁−Wᵢ) was not higher than 20%, then it was possible to suppress the occurrence of image deformation or image folding (comparative examples 2 and 12). However, in any of these cases, it was not possible to ensure image fixing properties.

Furthermore, in the cases where the fixing process was divided into a plurality of steps, if on at least one occasion the amount of change in the solvent content rate of the image before and after carrying out the fixing process by each heat fixing device (namely, Wᵢ₋₁−Wᵢ) exceeded 20% (and excluding cases where the solvent content rate Wᵢ₋₁ of the image immediately before carrying out the fixing process was not higher than 50%), then it was not possible to suppress the occurrence of image deformation or image folding (comparative examples 5 to 7, 8 to 10 and 15 to 22).

Thus, according to the present invention, by carrying out a fixing process in such a manner that the above-described condition (1) is satisfied, it is possible to ensure image fixing properties while suppressing the occurrence of image deformation or image folding.

As shown in FIG. 5, in the case of two heat fixing devices arranged in the sub-scanning direction, if a heating and pressing device (heating roller) is used as the heat fixing device that is disposed in the second position from the upstream side in the sub-scanning direction (in other words, the further downstream side in the sub-scanning direction), then it is possible to ensure satisfactory image fixing properties (practical examples 11 to 14). Further, of these examples, beneficial effects are obtained in terms of preventing image deformation if a heating and pressing device (heating roller) is used as the heat fixing device that is disposed in the first position from the upstream side in the sub-scanning direction (practical examples 11 and 12).

As shown in FIG. 6, by carrying out a step of drying the treatment liquid, beneficial effects are obtained in preventing image deformation and ensuring image fixing properties (practical examples 20 and 22).

As shown in FIG. 7, when using the ink containing polymer particles, if the rear surface side of the recording medium was heated to a temperature equal to or higher than the glass transition temperature Tg of the polymer particles, image deformation and adherence of the image to the recording medium conveyance member occurred, whereas if heated to a temperature lower than the glass transition temperature Tg of the polymer particles, then image deformation and adherence of the image to the recording medium conveyance member did not occur. Moreover, it was confirmed that compared to a case where no heating at all was applied, or where the ink that does not contain polymer particles was used, heating to a temperature lower than the glass transition temperature Tg of the polymer particles made it more possible to obtain satisfactory image fixing properties.

### Image Forming Apparatus

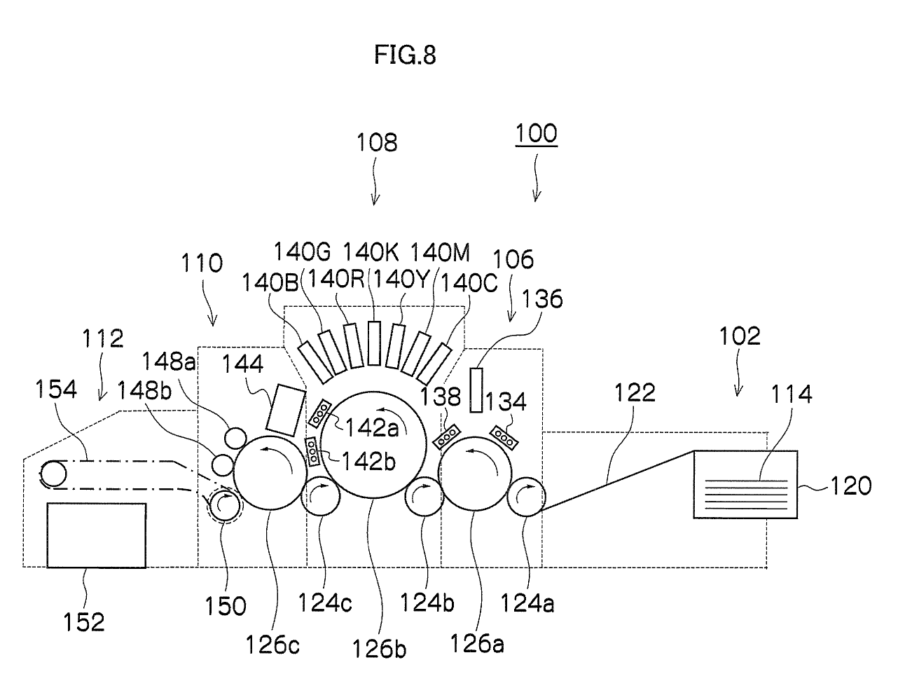

FIG. 8 is a general schematic drawing showing an inkjet recording apparatus as an image forming apparatus according to an embodiment of the present invention. The inkjet recording apparatus 100 shown in FIG. 8 is a recoding apparatus that employs a two-liquid aggregation system using ink and treatment liquid (aggregating treatment liquid) to form an image on a recording medium 114.

The inkjet recording apparatus 100 includes: a paper supply unit 102, which supplies the recording medium 114; a treatment liquid deposition unit 106, which deposits the treatment liquid on the recording medium 114; an ink deposition unit (print unit) 108, which forms an image by depositing droplets of colored ink onto the recording medium 114; a fixing unit 110, which fixes the image formed on the recording medium 114; and a paper output unit 112, which conveys and outputs the recording medium 114 on which the image has been formed.

The paper supply unit 102 is provided with a paper supply platform 120, on which the recording media 114 are stacked. A feeder board 122 is connected to the front (the left-hand side in FIG. 8) of the paper supply platform 120, and the recording media 114 stacked on the paper supply platform 120 are supplied one sheet at a time, successively from the uppermost sheet, to the feeder board 122. The recording medium 114 that has been conveyed to the feeder board 122 is transferred through a transfer drum 124a to a pressure drum (repellent agent drum) 126a of the treatment liquid deposition unit 106.

Although not shown in the drawings, holding hooks (grippers) and a suction port for holding the leading edge of the recording medium 114 are formed on the surface (circumferential surface) of the pressure drum 126a, and the recording medium 114 that has been transferred to the pressure drum 126a from the transfer drum 124a is conveyed in the direction of rotation (the counter-clockwise direction in FIG. 8) of the pressure drum 126a in a state where the leading edge is held by the holding hooks and the medium adheres tightly to the surface of the pressure drum 126a (in other words, in a state where the medium is wrapped about the pressure drum 126a). A similar composition is also employed for the other pressure drums 126b and 126c, which are described hereinafter.

The treatment liquid deposition unit 106 is provided with a paper preheating unit 134, a treatment liquid ejection head 136 and a treatment liquid drying unit 138 at positions opposing the surface of the pressure drum 126a, in this order from the upstream side in terms of the direction of rotation of the pressure drum 126a (the counter-clockwise direction in FIG. 8).

The treatment liquid ejection head 136 ejects and deposits droplets of the treatment liquid onto the recording medium 114 that is held on the pressure drum 126a. The treatment liquid ejection head 136 adopts the same composition as ink heads 140C, 140M, 140Y, 140K, 140R, 140G and 140B of the ink deposition unit 108, which is described below.

In the present embodiment, the inkjet head is used to deposit the treatment liquid onto the surface of the recording medium 114; however, the present invention is not limited to this, and it is possible to employ a spraying method, an application method, or other methods of various types.

The treatment liquid used in the present embodiment is an acidic liquid that has the action of aggregating the coloring materials contained in the inks that are ejected onto the recording medium 114 respectively from the ink heads 140C, 140M, 140Y, 140K, 140R, 140G and 140B disposed in the ink deposition unit 108, which is arranged at a downstream stage.

The treatment liquid drying unit 138 is provided with a hot air drying device blowing hot air of which the temperature and flow rate can be controlled within a prescribed range, thereby achieving a composition where the hot air heated by the hot air drying device is blown onto the treatment liquid on the recording medium 114 when the recording medium 114 that is held on the pressure drum 126a passes the position opposing the hot air drying device of the treatment liquid drying unit 138. In the present embodiment, the treatment liquid is dried by means of the hot air of 80° C.

The temperature and flow rate of the hot air drying device are set to values whereby the treatment liquid having been deposited on the recording medium 114 by the treatment liquid ejection head 136 disposed to the upstream side in terms of the direction of rotation of the pressure drum 126a is dried so that the solid or semi-solid aggregating treatment agent layer (the thin film layer of dried treatment liquid) is formed on the surface of the recording medium 114.

It is desirable that the recording medium 114 is preheated by the paper preheating unit 134, before depositing the treatment liquid on the recording medium 114, as in the present embodiment. In this case, it is possible to restrict the heating energy required to dry the treatment liquid to a low level, and therefore energy savings can be made. In the present embodiment, the paper preheating unit 134 has a composition similar to the treatment liquid drying unit 138.

The ink deposition unit 108 is arranged after the treatment liquid deposition unit 106. A transfer drum 124b is arranged between the pressure drum (treatment liquid drum) 126a of the treatment liquid deposition unit 106 and a pressure drum (print drum) 126b of the ink deposition unit (image forming drum) 108, so as to make contact with same. Hence, after the treatment liquid is deposited and the solid or semi-solid aggregating treatment agent layer is formed on the recording medium 114 that is held on the pressure drum 126a of the treatment liquid deposition unit 106, the recording medium 114 is transferred through the transfer drum 124b to the pressure drum 126b of the ink deposition unit 108.

The ink deposition unit 108 is provided with ink ejection heads 140C, 140M, 140Y, 140K, 140R, 140G and 140B, which correspond respectively to the seven colors of ink, C, M, Y, K, R, G and B, and solvent drying units 142a and 142b at positions opposing the surface of the pressure drum 126c, in this order from the upstream side in terms of the direction of rotation of the pressure drum 126c (the counter-clockwise direction in FIG. 8).

The ink ejection heads 140C, 140M, 140Y, 140K, 140R, 140G and 140B employ the inkjet type recording heads (inkjet heads), similarly to the above-described repellent agent ejection head 136. The ink ejection heads 140C, 140M, 140Y, 140K, 140R, 140G and 140B respectively eject droplets of corresponding colored inks onto the recording medium 114 held on the pressure drum 126b.

An ink storing and loading unit (not shown) is configured by ink tanks that store colored inks supplied to the ink ejection heads 140C, 140M, 140Y, 140K, 140R, 140G and 140B. Each ink tank communicates with a corresponding head through a required channel, and supplies the corresponding ink to the head. The ink storing and loading unit also includes a notification device (display device, alarm sound generator) such that when the residual amount of ink is small, the user is notified to this effect. In addition, the ink storing and loading unit includes a mechanism preventing the erroneous loading of colored inks.

The colored inks are supplied to the ink ejection heads 140C, 140M, 140Y, 140K, 140R, 140G and 140B from the tanks of the ink storing and loading unit, and droplets of the colored inks are ejected and deposited to the recording medium 114 by the ink ejection heads 140C, 140M, 140Y, 140K, 140R, 140G and 140B in accordance with the image signal.

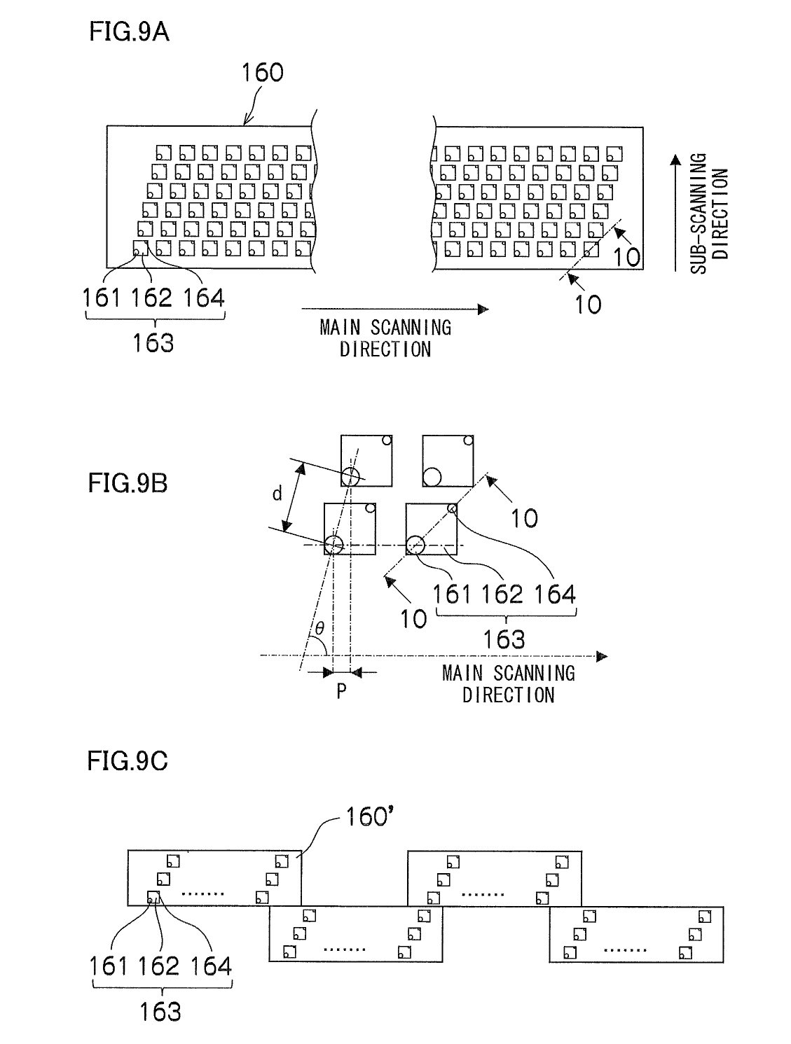

Each of the ink ejection heads 140C, 140M, 140Y, 140K, 140R, 140G and 140B is a full-line head having a length corresponding to the maximum width of the image forming region of the recording medium 114 held on the pressure drum 126b, and having a plurality of nozzles 161 (not shown in FIG. 8 and shown in FIGS. 9A to 9C) for ejecting the ink, which are arranged on the ink ejection surface of the head through the full width of the image forming region. The ink ejection heads 140C, 140M, 140Y, 140K, 140R, 140G and 140B are arranged so as to extend in a direction that is perpendicular to the direction of rotation of the pressure drum 126b (the conveyance direction of the recording medium 114).

According to the composition in which the full line heads having the nozzle rows covering the full width of the image forming region of the recording medium 114 are provided respectively for the colors of ink, it is possible to record a primary image on the image forming region of the recording medium 114 by performing just one operation of moving the recording medium 114 and the ink ejection heads 140C, 140M, 140Y, 140K, 140R, 140G and 140B relatively with respect to each other (in other words, by one sub-scanning action). Therefore, it is possible to achieve a higher printing speed compared to a case that uses a serial (shuttle) type of head moving back and forth reciprocally in the main scanning direction, which is the direction perpendicular to the sub-scanning direction or the conveyance direction of the recording medium 114, and hence it is possible to improve the print productivity.

The inkjet recording apparatus 100 according to the present embodiment is able to record on recording media (recording paper) up to a maximum size of 720 mm×520 mm and hence a drum having a diameter of 810 mm corresponding to the recording medium width of 720 mm is used for the pressure drum (print drum) 126c. The drum rotation peripheral speed when depositing the ink droplets is 530 mm/sec. The ink ejection volume of the ink ejection heads 140C, 140M, 140Y, 140K, 140R, 140G and 140B is 2 pl, and the recording density is 1200 dpi in both the main scanning direction (the breadthways direction of the recording medium 114) and the sub-scanning direction (the conveyance direction of the recording medium 114).

Although the configuration with the seven colors of C, M, Y, K, R, G and B is described in the present embodiment, the combinations of the ink colors and the number of colors are not limited to those. Light and/or dark inks, and special color inks can be added as required. For example, a configuration is possible in which ink heads for ejecting light-colored inks, such as light cyan and light magenta, are added. Furthermore, there is no particular restriction on the arrangement sequence of the heads of the respective colors.

Each of the solvent drying units 142a and 142b has a composition provided with a hot air drying device blowing hot air of which the temperature and flow rate can be controlled within a prescribed range, similarly to the paper preheating unit 134 and the treatment liquid drying unit 138, which have been described above. As described hereinafter, when ink droplets are deposited onto the solid or semi-solid aggregating treatment agent layer, which has been formed on the recording medium 114, an ink aggregate (coloring material aggregate) is formed on the recording medium 114, and furthermore, the ink solvent that has separated from the coloring material spreads, so that a liquid layer containing dissolved aggregating treatment agent is formed. The solvent component (liquid component) left on the recording medium 114 in this way is a cause of curling of the recording medium 114 and also leads to deterioration of the image. Therefore, in the present embodiment, after depositing the droplets of the colored inks from the ink ejection heads 140C, 140M, 140Y, 140K, 140R, 140G and 140B onto the recording medium 114, the hot air drying devices of the solvent drying units 142a and 142b blow the hot air of 70° C. onto the recording medium 114 so that the solvent component is evaporated off and the recording medium 114 is dried.

The fixing unit 110 is arranged after the ink deposition unit 108. A transfer drum 124c is arranged between the pressure drum (print drum) 126b of the ink deposition unit 108 and a pressure drum (fixing drum) 126c of the fixing unit 110, so as to make contact with same. Hence, after the colored inks are deposited on the recording medium 114 that is held on the pressure drum 126b of the ink deposition unit 108, the recording medium 114 is transferred through the transfer drum 124c to the pressure drum 126c of the fixing unit 110.

The fixing unit 110 is provided with a print determination unit 144, which reads in the print results of the ink deposition unit 108, and heating rollers 148a and 148b at positions opposing the surface of the pressure drum 126c, in this order from the upstream side in terms of the direction of rotation of the pressure drum 126c (the counter-clockwise direction in FIG. 8).

The print determination unit 144 includes an image sensor (a line sensor, or the like), which captures an image of the print result of the ink deposition unit 108 (the droplet ejection results of the ink ejection heads 140C, 140M, 140Y, 140K, 140R, 140G and 140B), and functions as a device for checking for nozzle blockages and other ejection defects, on the basis of the droplet ejection image captured through the image sensor.

The heating rollers 148a and 148b are rollers of which temperature can be controlled in a prescribed range (e.g., 50° C. to 180° C.), and the image formed on the recording medium 114 is fixed while nipping the recording medium 114 between the pressure drum 126c and each of the heating rollers 148a and 148b to heat and pressurize the recording medium 114.

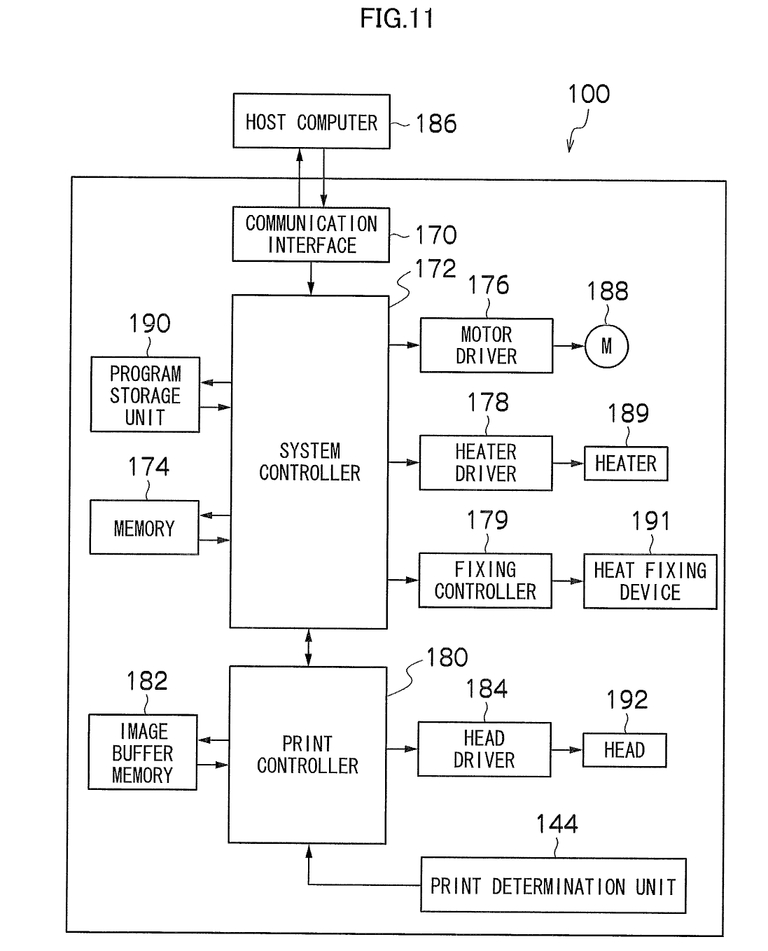

Each of the heating rollers (fixing rollers) 148a and 148b corresponds to the heating and pressing device that is an embodiment of the heat fixing device in the present invention. The fixing operation with each of the heating rollers 148a and 148b is controlled by a fixing control device (see FIG. 11) described later.

In the present embodiment, the heating temperatures of the heating rollers 148a and 148b are set to 60° C. and 75° C., and the surface temperature of the pressure drum 126c is set to 60° C. Furthermore, the nip pressures of the heating rollers 148a and 148b are 0.1 MPa and 1.0 MPa. It is desirable that the heating temperatures of the heating rollers 148a and 148b are set in accordance with the glass transition temperature of the polymer particles contained in the treatment liquid or the ink.

As the fixing roller, various kinds of rollers can be used. It is desirable that the fixing roller has elasticity (flexibility).

Examples of the fixing roller include: a roller with a single-layered configuration, in which a core member of the roller is covered with an elastic layer; a roller with a double-layered configuration, in which the elastic layer is further covered with a releasing layer; and a roller with a triple-layered configuration, in which an intermediate layer is further arranged between the elastic layer and the releasing layer.

As the core member of the fixing roller, various kinds of members having sufficient strength with respect to pressure can be used. It is desirable that the core member is made of a material having satisfactory heat conductivity. Specific examples of the core member include: a roller made of an aluminum material such as A5056, A5052, A5083, and A6063; and a roller made of non-magnetic stainless steel such as STKM11. In an embodiment of the present invention, the fixing roller has a built-in heat souse (e.g., a lamp heater), and a hollow cylindrical member is used as the core member.

The elastic layer may be formed of synthetic rubber such as silicone rubber and fluoro-rubber. In particular, in a case of a roller with the single-layered configuration, low-temperature vulcanizing (LTV) silicone rubber having an excellent releasing property with respect to the recording medium on which an image has been formed. Preferable examples of the fluoro-rubber include Viton (manufactured by Dupont). Moreover, in order to enhance the heat conductivity during fixation by heating, it is preferable to mix 5 to 30 wt % of powder of a metal oxide such as silica, alumina, and magnesia as a filler. Furthermore, for the same reason, conductive carbon black may be used as a filler. In this case, the electrical resistance of the elastic layer is reduced, so that it is possible to prevent charging. The elastic layer has a thickness of 1 to 8 mm. The hardness of rubber is adjusted to a value suitable for the present invention in a range of 10 to 80 measured by the type A durometer in accordance with JIS K 6253-1997.

The releasing layer is provided for enhancing the releasability with respect to the recording medium. The releasing layer may be formed by covering the elastic layer with a tube made of fluoro-resin such as PFA, or by applying fluoro-resin coating such as PTFE, PFA, and FEP on the surface of the elastic layer. The releasing layer has a thickness of 10 to 100 μm.

In the present embodiment, the fixing roller is provided with the elastic layer formed of silicone rubber having 4 mm thick and the rubber hardness of 70, and the releasing layer formed of a tube of PFA having 30 μm thick.

It is also desirable that the fixing roller has the triple-layered configuration in which the surface of the elastic layer is covered with the intermediate layer formed by mixing fluoro-rubber with fluoro-resin, and the releasing layer is arranged over the intermediate layer, so that the adhesion between the elastic layer and the releasing layer can be enhanced and the damage (e.g., occurrence of cracks) of the releasing layer can be prevented due to the buffer action of the intermediate layer.

It is also desirable that the fixing roller has the triple-layered configuration in which the elastic layer is formed of high-temperature vulcanizing (HTV) silicone rubber having excellent heat resistance, the intermediate layer formed of fluoro-rubber is arranged over the elastic layer for preventing the swelling of the elastic layer, and the releasing layer formed of LTV silicone rubber is arranged over the intermediate layer.

In the present embodiment, the dimensions relating the fixing roller, such as the diameter and the thickness of the core member, the width, the diameter and the length of the shaft, may be suitably designed.

In particular, the fixing roller usually has the fixed sectional shape perpendicular to the axis direction in which the thicknesses of the core member and the elastic layer are unchanged; however, it is possible to vary the thicknesses in positions along the axis direction to give consideration to factors such as the bend of the roller and the wrinkles of the recording medium, and the fixing roller may have so-called a crown shape or a reverse crown shape.

In addition, as the fixing roller, it is also desirable to use a soft roller in which the core member is covered with a silicone rubber layer, a fluoro-rubber layer, or a foaming rubber layer in a sponge shape using a foaming material such as silicone rubber. Moreover, it is desirable to use a hard roller in which the core member is covered with fluoro-resin such as PTFE, PFA, and FEP, or a PFT tube.

As the fixing roller, any of known rollers can be used, provided that it withstands the pressure of the heat fixing. In a case where the fixing roller has a built-in heat source, it is naturally desirable that the fixing roller is made of material having sufficient heat conductivity.

The paper output unit 112 is arranged after the fixing unit 110. The paper output unit 112 is provided with a paper output drum 150, which receives the recording medium 114 on which the image has been fixed, a paper output platform 152, on which the recording media 114 are stacked, and a paper output chain 154 having a plurality of paper output grippers, which is spanned between a sprocket arranged on the paper output drum 150 and a sprocket arranged above the paper output platform 152.

Next, the structure of the ink ejection heads 140C, 140M, 140Y, 140K, 140R, 140G and 140B disposed in the ink deposition unit 108 is described in detail. The ink ejection heads 140C, 140M, 140Y, 140K, 140R, 140G and 140B have a common structure, and in the following description, these ink ejection heads are represented by an ink ejection head (hereinafter, simply called a “head”) denoted with reference numeral 160.

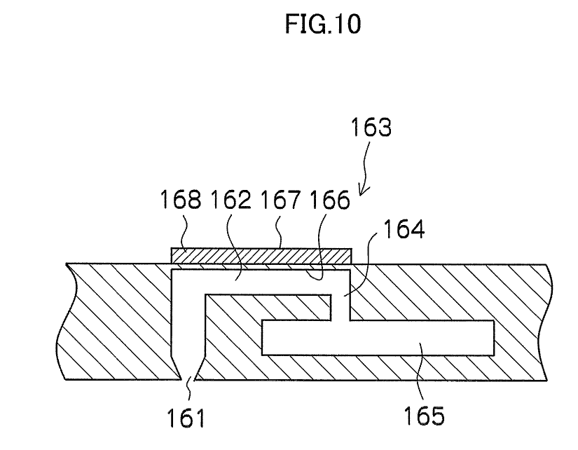

FIG. 9A is a plan view perspective diagram showing an embodiment of the structure of the head 160; FIG. 9B is an enlarged diagram showing a portion of the head; and FIG. 9C is a plan view perspective diagram showing a further embodiment of the structure of the head 160. FIG. 10 is a cross-sectional diagram along line 10-10 in FIGS. 9A and 9B, and shows the three-dimensional composition of an ink chamber unit.

The nozzle pitch in the head 160 should be minimized in order to maximize the density of the dots formed on the surface of the recording medium 114. As shown in FIGS. 9A and 9B, the head 160 according to the present embodiment has a structure in which a plurality of ink chamber units 163, each having a nozzle 161 forming an ink droplet ejection port, a pressure chamber 162 corresponding to the nozzle 161, and the like, are disposed two-dimensionally in the form of a staggered matrix, and hence the effective nozzle interval (the projected nozzle pitch) as projected in the lengthwise direction of the head (the main-scanning direction perpendicular to the recording medium conveyance direction) is reduced and high nozzle density is achieved.

The mode of forming one or more nozzle rows through a length corresponding to the entire width of the recording area of the recording medium 114 in a direction substantially perpendicular to the conveyance direction of the recording medium 114 is not limited to the embodiment described above. For example, instead of the configuration in FIG. 9A, as shown in FIG. 9C, a line head having the nozzle rows of the length corresponding to the entire width of the recording area of the recording medium 114 can be formed by arranging and combining, in a staggered matrix, short head blocks 160′ each having a plurality of nozzles 161 arrayed two-dimensionally. Furthermore, although not shown in the drawings, it is also possible to compose a line head by arranging short heads in one row.

The pressure chamber 162 provided corresponding to each of the nozzles 161 is approximately square-shaped in plan view, and the nozzle 161 and a supply port 164 are arranged respectively at corners on a diagonal of the pressure chamber 162. Each pressure chamber 162 is connected through the supply port 164 to a common flow channel 165. The common flow channel 165 is connected to an ink supply tank (not shown), which is a base tank that supplies ink, and the ink supplied from the ink supply tank is delivered through the common flow channel 165 to the pressure chambers 162.

A piezoelectric element 168 provided with an individual electrode 167 is bonded to a diaphragm 166, which forms the upper face of the pressure chamber 162 and also serves as a common electrode, and the piezoelectric element 168 is deformed when a drive voltage is applied to the individual electrode 167, thereby causing the ink to be ejected from the nozzle 161. When the ink is ejected, new ink is supplied to the pressure chamber 162 from the common flow passage 165 through the supply port 164.

In the present embodiment, the piezoelectric element 168 is used as an ink ejection force generating device, which causes the ink to be ejected from the nozzle 160 in the head 161; however, it is also possible to employ a thermal method in which a heater is provided inside the pressure chamber 162 and the ink is ejected by using the pressure of the film boiling action caused by the heating action of this heater.

As shown in FIG. 9B, the high-density nozzle head according to the present embodiment is achieved by arranging the plurality of ink chamber units 163 having the above-described structure in a lattice fashion based on a fixed arrangement pattern, in a row direction that coincides with the main scanning direction, and a column direction that is inclined at a fixed angle of θ with respect to the main scanning direction, rather than being perpendicular to the main scanning direction.

More specifically, by adopting the structure in which the plurality of ink chamber units 163 are arranged at the uniform pitch d in line with the direction forming the angle of θ with respect to the main scanning direction, the pitch P of the nozzles projected so as to align in the main scanning direction is d×cos θ, and hence the nozzles 161 can be regarded to be equivalent to those arranged linearly at the fixed pitch P along the main scanning direction. Such configuration results in the nozzle structure in which the nozzle row projected in the main scanning direction has a high nozzle density of up to 2,400 nozzles per inch.

When implementing the present invention, the arrangement structure of the nozzles is not limited to the embodiment shown in the drawings, and it is also possible to apply various other types of nozzle arrangements, such as an arrangement structure having one nozzle row in the sub-scanning direction.

Furthermore, the scope of application of the present invention is not limited to a printing system based on the line type of head, and it is also possible to adopt a serial system where a short head that is shorter than the breadthways dimension of the recording medium 114 is moved in the breadthways direction (main scanning direction) of the recording medium 114, thereby performing printing in the breadthways direction, and when one printing action in the breadthways direction has been completed, the recording medium 114 is moved through a prescribed amount in the sub-scanning direction perpendicular to the breadthways direction, printing in the breadthways direction of the recording medium 114 is carried out in the next printing region, and by repeating this sequence, printing is performed over the whole surface of the printing region of the recording medium 114.

FIG. 11 is a principal block diagram showing the system configuration of the image forming apparatus 100. The image forming apparatus 100 includes a communication interface 170, a system controller 172, a memory 174, a motor driver 176, a heater driver 178, a fixing controller 179, a print controller 180, an image buffer memory 182, a head driver 184, and the like.

The communication interface 170 is an interface unit for receiving image data sent from a host computer 186. A serial interface such as USB (Universal Serial Bus), IEEE1394, Ethernet, wireless network, or a parallel interface such as a Centronics interface may be used as the communication interface 170. A buffer memory (not shown) may be mounted in this portion in order to increase the communication speed. The image data sent from the host computer 186 is received by the image forming apparatus 100 through the communication interface 170, and is temporarily stored in the memory 174.

The memory 174 is a storage device for temporarily storing image data inputted through the communication interface 170, and data is written and read to and from the memory 174 through the system controller 172. The memory 174 is not limited to a memory composed of semiconductor elements, and a hard disk drive or another magnetic medium may be used.

The system controller 172 is constituted of a central processing unit (CPU) and peripheral circuits thereof, and the like, and it functions as a control device for controlling the whole of the image forming apparatus 100 in accordance with a prescribed program, as well as a calculation device for performing various calculations. More specifically, the system controller 172 controls the various sections, such as the communication interface 170, memory 174, motor driver 176, heater driver 178, fixing controller 179, and the like, as well as controlling communications with the host computer 186 and writing and reading to and from the memory 174, and it also generates control signals for controlling the motor 188 and heater 189 of the conveyance system.

The program executed by the CPU of the system controller 172 and the various types of data which are required for control procedures are stored in the memory 174. The memory 174 may be a non-rewriteable storage device, or it may be a rewriteable storage device, such as an EEPROM. The memory 174 is used as a temporary storage region for the image data, and it is also used as a program development region and a calculation work region for the CPU.

Various control programs are stored in the program storage unit 190, and a control program is read out and executed in accordance with commands from the system controller 172. The program storage unit 190 may use a semiconductor memory, such as a ROM, EEPROM, or a magnetic disk, or the like. An external interface may be provided, and a memory card or PC card may also be used. Naturally, a plurality of these recording media may also be provided. The program storage unit 190 may also be combined with a storage device for storing operational parameters, and the like (not shown).

The motor driver 176 is a driver that drives the motor 188 in accordance with instructions from the system controller 172. In FIG. 11, the plurality of motors (actuators) disposed in the respective sections of the image forming apparatus 100 are represented by the reference numeral 188. For example, the motor 188 shown in FIG. 11 includes the motors that drive the pressure drums 126a to 126c, the transfer drums 124a to 124c and the paper output drum 150, shown in FIG. 8.

The heater driver 178 is a driver that drives the heater 189 in accordance with instructions from the system controller 172. In FIG. 11, the plurality of heaters disposed in the image forming apparatus 100 are represented by the reference numeral 189. For example, the heater 189 shown in FIG. 11 includes the heaters of the paper preheating unit 134, the treatment liquid drying unit 138, the hot air drying devices provided in the solvent drying units 142a and 142b, and the like, shown in FIG. 8.

The fixing controller 179 controls the fixing process with the heat fixing device 191 in accordance with instructions from the print controller 180. In FIG. 11, the plurality of heat fixing devices disposed in the image forming apparatus 100 are represented by the reference numeral 191. For example the heat fixing device 191 shown in FIG. 11 includes the heating rollers 148a and 148b shown in FIG. 8. The most suitable fixing conditions including the heating temperatures, heating durations (fixing durations), and pressures (nipping pressures) of the heating rollers 148a and 148b are determined for each of combinations of various types of recording medium 114 and inks, and this information is stored in a prescribed memory (for example, the memory 174) in the form of a data table in advance, in such a manner that the memory is read and the heating temperatures, heating durations, and pressures of the heating rollers 148a and 148b are controlled accordingly whenever information relating to the recording medium 114 and inks used is acquired.

The print controller 180 is a control unit that has signal processing functions for carrying out processing, correction, and other treatments in order to generate a print control signal on the basis of the image data in the memory 174 in accordance with the control of the system controller 172. The print controller 180 supplies the print data (dot data) thus generated to the head driver 184. Prescribed signal processing is carried out in the print controller 180, and the ejection volume and the ejection timing of the ink droplets in the head 160 are controlled through the head driver 184 on the basis of the image data. By this means, prescribed dot size and dot positions can be achieved. In FIG. 11, the plurality of heads (inkjet heads) disposed in the inkjet recording apparatus 100 are represented by the reference numeral 192. For example, the head 192 shown in FIG. 11 includes the ink ejection heads 140C, 140M, 140Y, 140K, 140R, 140G and 140B shown in FIG. 8.

The print controller 180 is provided with the image buffer memory 182, and image data, parameters, and other data are temporarily stored in the image buffer memory 182 when image data is processed in the print controller 180. Also possible is an aspect in which the print controller 180 and the system controller 172 are integrated to form a single processor.

The head driver 184 generates drive signals to be applied to the piezoelectric elements 168 of the head 192, on the basis of image data supplied from the print controller 180, and also has drive circuits which drive the piezoelectric elements 168 by applying the drive signals to the piezoelectric elements 168. A feedback control system for maintaining constant drive conditions in the head 192 may be included in the head driver 184 shown in FIG. 11.

The print determination unit 144 is a block that includes the line sensor as described above with reference to FIG. 8, reads the image printed on the recording medium 114, determines the print conditions (presence of the ejection, variation in the dot formation, and the like) by performing desired signal processing, or the like, and provides the determination results of the print conditions to the print controller 180. According to requirements, the print controller 180 makes various corrections with respect to the head 192 on the basis of information obtained from the print determination unit 144.

The operation of the image forming apparatus 100 which has this composition is described below.

The recording medium 114 is conveyed to the feeder board 122 from the paper supply platform 120 of the paper supply unit 102, and is transferred through the transfer drum 124a onto the pressure drum 126a of the treatment liquid deposition unit 106. The recording medium 114 held on the pressure drum 126a is preheated by the paper preheating unit 134 and droplets of the treatment liquid are deposited by the treatment liquid head 136. Thereupon, the recording medium 114 held on the pressure drum 126a is heated by the treatment liquid drying unit 138, and the solvent component (liquid component) of the treatment liquid is evaporated and the recording medium 114 is thereby dried. Thus, a solid or semi-solid aggregating treatment agent layer is formed on the recording medium 114.

The recording medium 114 on which the solid or semi-solid aggregating treatment agent layer has been formed is transferred from the pressure drum 126a of the treatment liquid deposition unit 106 though the transfer drum 124b to the pressure drum 126b of the ink deposition unit 108. Droplets of corresponding colored inks are ejected respectively from the ink ejection heads 140C, 140M, 140Y, 140K, 140R, 140G and 140B, onto the recording medium 114 held on the pressure drum 126b, in accordance with the input image data.

The ink droplets ejected from the heads 140C, 140M, 140Y, 140K, 140R, 140G and 140B are deposited onto the solid or semi-solid aggregating treatment agent layer formed on the recording medium 114. At this time, the contact interface between each ink droplet and the aggregating treatment agent layer has a prescribed area when the ink droplet lands, due to a balance between the kinetic energy and the surface energy. The aggregating reaction starts immediately after the ink droplets have landed on the aggregating treatment agent, and the aggregating reaction starts from the surface of each ink droplet in contact with the aggregating treatment agent layer. Since the aggregating reaction occurs only in the vicinity of the contact surface, and the coloring material in the ink aggregates while the ink droplet obtains an adhesive force in the prescribed contact interface area upon landing of the ink droplet, then movement of the coloring material is suppressed.

Even if another ink droplet is subsequently deposited adjacently to the ink droplet deposited previously, since the coloring material of the previously deposited ink has already aggregated, then the coloring material does not mix with the subsequently deposited ink, and therefore bleeding is suppressed. After the aggregation of the coloring material, the separated ink solvent spreads, and a liquid layer containing dissolved aggregating treatment agent is formed on the recording medium 114.

Thereupon, the recording medium 114 held on the pressure drum 126b is heated by the solvent drying units 142a and 142b, and the solvent component (liquid component) that has been separated from the ink aggregate on the recording medium 114 is evaporated off and the recording medium 114 is thereby dried. Thus, curling of the recording medium 114 is prevented, and furthermore deterioration of the image quality as a result of the presence of the solvent component can be restricted.

The recording medium 114 onto which the colored inks have been deposited by the ink deposition unit 108 is transferred from the pressure drum 126b of the ink deposition unit 108 through the transfer drum 124c to the pressure drum 126c of the fixing unit 110. The print results produced by the print unit 108 on the recording medium 114 held on the pressure drum 126c are read in by the print determination unit 144, whereupon the recording medium 114 is heated and pressured by the heating rollers 148a and 148b to fix the image formed on the recording medium 114.

At this time, the fixing controller 179 (see FIG. 11) controls the fixing process with the heating rollers 148a and 148b to satisfy the above-described condition (1), so that it is possible to ensure fixing properties while avoiding the occurrence of image deformation and image folding.

Then, the recording medium 114 on which the image has been fixed is transferred from the pressure drum 126c to the paper output drum 150. The recording medium 114is then conveyed onto the paper output platform 152 by the paper output chain 154, and is stacked on the paper output platform 152.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming apparatus which forms an image on a recording medium by using an ink and a treatment liquid, the ink containing coloring material, the treatment liquid containing a component which causes the coloring material to aggregate, the apparatus comprising:
a treatment liquid deposition device which deposits the treatment liquid onto the recording medium;
an ink droplet ejection device which ejects and deposits droplets of the ink onto the recording medium;
a plurality of heat fixing devices which perform fixing process of the image formed on the recording medium by removing stepwise a solvent component contained in the image, the heat fixing devices being arranged sequentially in a conveyance direction of the recording medium; and
a fixing control device which controls the fixing process with the heat fixing devices so as to satisfy the following condition:
if Wᵢ₋₁>50, then Wᵢ₋₁−Wᵢ≦20,
where n is a number of the heat fixing devices, Wᵢ (%) is a solvent content rate of the image after the fixing process has been carried out by one of the heat fixing devices in an i-th position (where i is a natural number not larger than n) from an upstream side in the conveyance direction of the recording medium, and W₀ (%) is a solvent content rate of the image before carrying out the fixing process by a first one of the heat fixing devices from the upstream side in the conveyance direction of the recording medium.

2. The image forming apparatus as defined in claim 1, wherein the ink contains polymer particles.

3. The image forming apparatus as defined in claim 2, wherein the fixing control device controls the fixing process with the heat fixing devices so as to satisfy Wₙ≦25, where Wₙ (%) is a solvent content rate of the image after carrying out the fixing process by one of the heat fixing devices in an n-th position from the upstream side in the conveyance direction of the recording medium.

4. The image forming apparatus as defined in claim 1, wherein:
the ink does not contain polymer particles; and
the fixing control device controls the fixing process with the heat fixing devices so as to satisfy Wₙ≦15, where Wₙ (%) is a solvent content rate of the image after carrying out the fixing process by one of the heat fixing devices in an n-th position from the upstream side in the conveyance direction of the recording medium.

5. The image forming apparatus as defined in claim 1, wherein one of the heat fixing devices in an n-th position from the upstream side in the conveyance direction of the recording medium is a heating and pressing device which fixes the image formed on the recording medium by heating and pressing the image.

6. The image forming apparatus as defined in claim 5, wherein at least one of the fixing devices in the i-th position (excluding a case where i=n) is a heating and pressing device which fixes the image formed on the recording medium by heating and pressing the image.

7. The image forming apparatus as defined in claim 1, further comprising a heating device which applies heat from a side opposite to an image forming surface of the recording medium.

8. The image forming apparatus as defined in claim 7, wherein:
the ink contains polymer particles; and
a heating temperature of the heating device is lower than a glass transition temperature of the polymer particles.

9. The image forming apparatus as defined in claim 1, further comprising a treatment liquid drying device which dries the treatment liquid deposited on the recording medium and renders the treatment liquid to a solid or semi-solid state.

10. The image forming apparatus as defined in claim 1, wherein the recording medium is a coated paper.

11. The image forming apparatus as defined in claim 1, wherein the ink droplet ejection device ejects droplets of the ink by a single-pass method.

12. A method of forming an image on a recording medium by using an ink and a treatment liquid, the ink containing coloring material, the treatment liquid containing a component which causes the coloring material to aggregate, the method comprising:
a treatment liquid deposition step of depositing the treatment liquid onto the recording medium;
an ink droplet deposition step of ejecting and depositing droplets of the ink onto the recording medium; and
a fixing step of performing fixing process of the image formed on the recording medium by removing stepwise a solvent component contained in the image by heat fixing devices arranged sequentially in a conveyance direction of the recording medium,
wherein the fixing process with the heat fixing devices is controlled to satisfy the following condition:
if Wᵢ₋₁>50, then Wᵢ₋₁−Wᵢ≦20,
where n is a number of the heat fixing devices, Wᵢ (%) is a solvent content rate of the image after the fixing process has been carried out by one of the heat fixing devices in an i-th position (where i is a natural number not larger than n) from an upstream side in the conveyance direction of the recording medium, and W₀ (%) is a solvent content rate of the image before carrying out the fixing process by a first one of the heat fixing devices from the upstream side in the conveyance direction of the recording medium.
